(19) United States
(12) Patent Application Publication
(10) Pub. No.: US 2016/0094896 A1
(43) Pub. Date: Mar. 31, 2016

(54) INFORMATION PROVIDING SYSTEM AND INFORMATION PROVIDING METHOD

(71) Applicant: Panasonic Intellectual Property Management Co., Ltd., Osaka (JP)

(72) Inventors: Kouichi MATSUMURA, Osaka (JP); Sako KONDO, Osaka (JP)

(21) Appl. No.: 14/868,633

(22) Filed: Sep. 29, 2015

(30) Foreign Application Priority Data
Sep. 30, 2014 (JP) 2014-202054

(51) Int. Cl. H04N 21/84; H04N 21/436; H04N 21/81; H04N 21/222; H04N 21/2665; H04N 21/462

(52) U.S. Cl. CPC H04N 21/84; H04N 21/2665; H04N 21/4622; H04N 21/812; H04N 21/222; H04N 21/436

(57) ABSTRACT

An information providing system includes a supplementary information server that provides supplementary information related to video to be broadcasted, a video receiving device that receives via broadcast the video and first specifying information for specifying the supplementary information related to the video, a terminal device that receives the first specifying information from the video receiving device and second specifying information for specifying the supplementary information from another apparatus different from the video receiving device, and a management unit that discriminates between the first specifying information and the second specifying information to manage frequency with which the terminal device receives the first specifying information.

### BACKGROUND

1. Technical Field

The present disclosure relates to an information providing system and information providing method for providing supplementary information related to video content in parallel with broadcast of the video content.

2. Description of the Related Art

Conventionally proposed information providing systems provide, in parallel with video content, such as television programs, supplementary information related to the video content. With such an information providing system, for example, while a user is watching a television program on television, the supplementary information related to content of the television program is displayed on a terminal device, such as a smart phone, wirelessly connected to the television. The supplementary information is, for example, advertisement information related to the television program being watched, or detailed information on the television program (such as information that introduces characters).

It is said that too little arrival frequency of an advertisement to a subject leads to a small cognitive effect of the advertisement, and conversely, a too great arrival frequency leads to an adverse effect because the subject loses interest. Therefore, it is required to appropriately grasp the arrival frequency of the advertisement to the subject for effective advertisement distribution.

For example, Japanese Patent No. 5121729 discloses a technique of estimating the arrival frequency of an advertisement by using broadcast frequency of the advertisement and ratings of a television program.

### SUMMARY

An information providing system according to the present disclosure is an information providing system for providing broadcast of video content and supplementary information related to the video content. The information providing system includes: a supplementary information server that provides supplementary information specified from among one or more pieces of supplementary information respectively related to one or more pieces of video content to be broadcasted; a video receiving device that receives, via broadcast, video content and first specifying information for specifying the supplementary information related to the video content; a terminal device that receives the first specifying information from the video receiving device, and second specifying information for specifying the supplementary information from another apparatus different from the video receiving device; and a management unit that discriminates between the first specifying information and the second specifying information, and manages frequency with which the terminal device receives the first specifying information.

### BRIEF DESCRIPTION OF DRAWINGS

FIG. 1 is a diagram illustrating a configuration of an information providing system according to a first exemplary embodiment;

FIG. 2 is a diagram illustrating a flow of information in the information providing system according to the first exemplary embodiment;

FIG. 3 is a block diagram illustrating a functional configuration of a broadcasting station (video transmitting device) according to the first exemplary embodiment;

FIG. 4 is a block diagram illustrating a functional configuration of a television (video receiving device) according to the first exemplary embodiment;

FIG. 5 is a block diagram illustrating a functional configuration of a terminal device according to the first exemplary embodiment;

FIG. 6 is a block diagram illustrating a functional configuration of a CM supplementary advertisement server (supplementary information server) according to the first exemplary embodiment;

FIG. 7 is a diagram illustrating a CM supplementary advertisement management table according to the first exemplary embodiment;

FIG. 8 is a diagram illustrating a CM arrival frequency management table according to the first exemplary embodiment;

FIG. 9 is a sequence diagram illustrating an operation of the information providing system according to the first exemplary embodiment;

FIG. 10 is a diagram illustrating the configuration of the information providing system according to a second exemplary embodiment;

FIG. 11 is a diagram illustrating a flow of information in the information providing system according to the second exemplary embodiment;

FIG. 12 is a block diagram illustrating a functional configuration of the broadcasting station (video transmitting device) according to the second exemplary embodiment;

FIG. 13 is a block diagram illustrating a functional configuration of the terminal device according to the second exemplary embodiment;

FIG. 14 is a block diagram illustrating a functional configuration of the CM supplementary advertisement server (supplementary information server) according to the second exemplary embodiment;

FIG. 15 is a diagram illustrating the CM supplementary advertisement management table according to the second exemplary embodiment;

FIG. 16 is a sequence diagram illustrating the operation of the information providing system according to the second exemplary embodiment;

FIG. 17 is a diagram illustrating the configuration of the information providing system according to a third exemplary embodiment;

FIG. 18 is a diagram illustrating a flow of information in the information providing system according to the third exemplary embodiment;

FIG. 19 is a block diagram illustrating a functional configuration of the television (video receiving device) according to the third exemplary embodiment;

FIG. 20 is a block diagram illustrating a functional configuration of the CM supplementary advertisement server (supplementary information server) according to the third exemplary embodiment;

FIG. 21 is a sequence diagram illustrating the operation of the information providing system according to the third exemplary embodiment;

FIG. 22 is a diagram illustrating the configuration of the information providing system according to a fourth exemplary embodiment;

FIG. 23 is a block diagram illustrating a functional configuration of a network advertisement server (network information server) according to the fourth exemplary embodiment;

FIG. 24 is a diagram illustrating a network advertisement management table according to the fourth exemplary embodiment; and

FIG. 25 is a sequence diagram illustrating the operation of the information providing system according to the fourth exemplary embodiment.

### DETAILED DESCRIPTION

Exemplary embodiments will be described in detail below with reference to the drawings as needed. However, an unnecessarily detailed description may be omitted. For example, a detailed description of an already well-known item and a repeated description of substantially identical components may be omitted. This is for avoiding the following description from becoming unnecessarily redundant and for making the description easier for a person skilled in the art to understand.

It is to be noted that the inventors provide the accompanying drawings and the following description in order for a person skilled in the art to fully understand the present disclosure, and do not intend to limit the subject described in the appended claims.

Each diagram is a schematic view and is not necessarily illustrated strictly. In each diagram, like reference numerals denote like elements.

### First Exemplary Embodiment

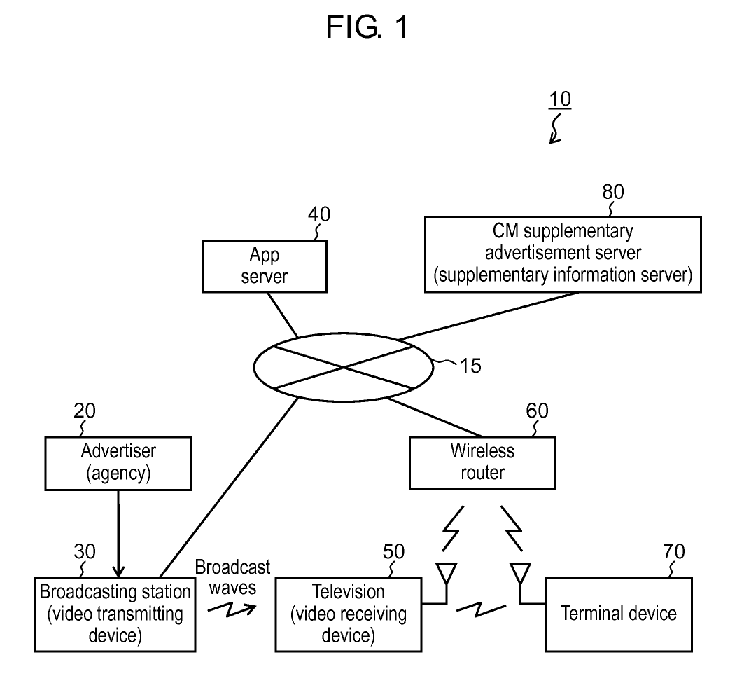

An information providing system and information providing method according to a first exemplary embodiment will be described below with reference to FIG. 1 to FIG. 9.

### [1-1. Configuration]

### [1-1-1. Overall Configuration of the System]

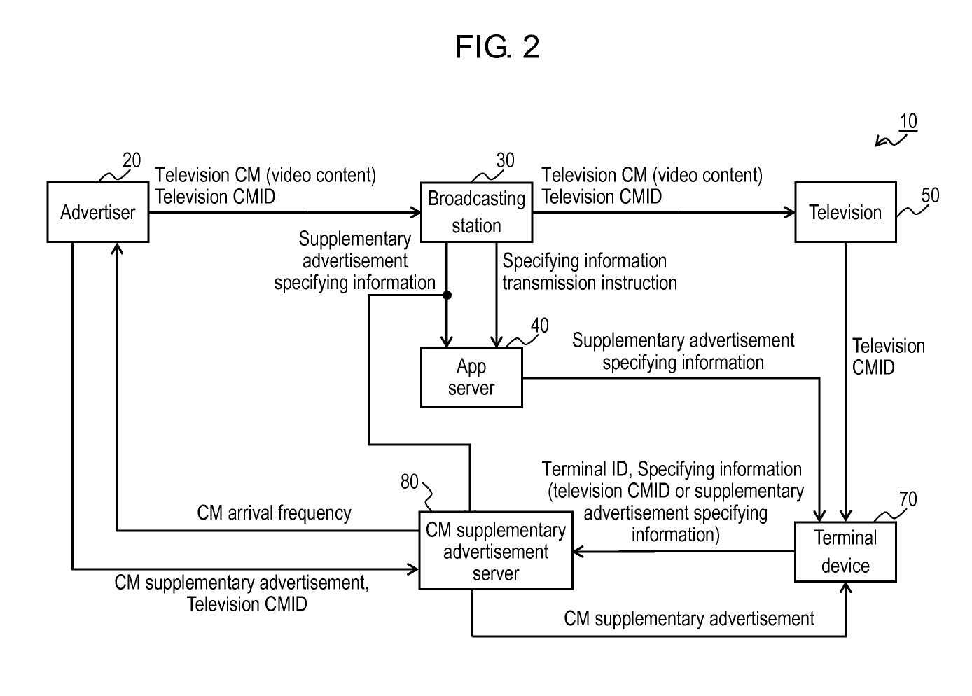

FIG. 1 is a diagram illustrating a configuration of information providing system 10 according to the present exemplary embodiment. FIG. 2 is a diagram illustrating a flow of information in information providing system 10 according to the present exemplary embodiment.

Information providing system 10 is a system that provides supplementary information related to video content in parallel with broadcast of the video content.

The video content is, for example, a Commercial Message to be broadcasted (hereinafter referred to as CM). The CM to be broadcasted is hereinafter described as a television CM. The video content may also be a television program, such as news and a drama, for example. The supplementary information is, for example, advertisement information related to the television CM, or detailed information on the television program (for example, information that introduces characters).

As illustrated in FIG. 1, information providing system 10 includes television 50, terminal device 70, and CM supplementary advertisement server 80. Information providing system 10 further includes advertiser 20, broadcasting station 30, App server 40, and wireless router 60. CM supplementary advertisement server 80, App server 40, and wireless router 60 are connected via communication network 15. Note that App mentioned here is an abbreviation of an application program.

Communication network 15 is a communication path that connects App server 40, wireless router 60, and CM supplementary advertisement server 80. Communication network 15 is, for example, the Internet.

Advertiser 20 is an example of an advertising agency that creates a television CM and a CM supplementary advertisement. As illustrated in FIG. 2, advertiser 20 transmits the created television CM together with a television CM ID corresponding to the television CM to broadcasting station 30. Advertiser 20 also transmits the created CM supplementary advertisement together with specifying information for specifying the CM supplementary advertisement to CM supplementary advertisement server 80. In the present exemplary embodiment, advertiser 20 transmits the CM supplementary advertisement and the television CM ID to CM supplementary advertisement server 80. Broadcasting station 30 may transmit the CM supplementary advertisement and the television CM ID to CM supplementary advertisement server 80.

The CM supplementary advertisement is an example of advertisement supplementary information that indicates information on the television CM in detail. Specifically, the CM supplementary advertisement is advertisement information that supplements the television CM. For example, the CM supplementary advertisement is information that indicates details such as how to use and from which supplier to purchase a product and the like advertised by the television CM. The CM supplementary advertisement is distributed via communication network 15 in conjunction with broadcast of the corresponding television CM. Specifically, the CM supplementary advertisement is distributed during broadcast of the corresponding television CM and is displayed on terminal device 70.

The television CM ID is an identifier allocated to each television CM so that the television CM ID may not be duplicated. In the present exemplary embodiment, the television CM ID is used as first specifying information for specifying the CM supplementary advertisement.

Broadcasting station 30 is an example of a transmitting device that transmits the video content and the first specifying information via broadcast. In the present exemplary embodiment, broadcasting station 30 broadcasts the television CM by broadcast waves and transmits, at an arbitrary timing, the television CM ID of the television CM being broadcasted. Broadcast is not limited to broadcast waves, but may be wire broadcast such as cable TV.

In the present exemplary embodiment, broadcasting station 30 further generates supplementary advertisement specifying information, and transmits the generated supplementary advertisement specifying information to App server 40 and CM supplementary advertisement server 80. The supplementary advertisement specifying information is an example of second specifying information for specifying the CM supplementary advertisement. Specifically, the supplementary advertisement specifying information is information for specifying the CM supplementary advertisement specified by the television CM ID. That is, the supplementary advertisement specifying information (second specifying information) is information different from the television CM ID (first specifying information), but is information for specifying the identical CM supplementary advertisement.

The television CM ID and the supplementary advertisement specifying information may, for example, have an identical format and different content. For example, when the television CM ID is expressed by a 10-digit numerical value, the supplementary advertisement specifying information may be a 10-digit numerical value calculated through addition of a predetermined value to the television CM ID. Alternatively, the format may differ between the television CM ID and the supplementary advertisement specifying information. For example, a bit count may differ between the television CM ID and the supplementary advertisement specifying information.

Broadcasting station 30 also transmits a specifying information transmission instruction to App server 40 at predetermined timing. The specifying information transmission instruction is an instruction for causing App server 40 to transmit the supplementary advertisement specifying information. For example, broadcasting station 30 transmits the specifying information transmission instruction at same timing as transmitting the television CM ID by broadcast.

App server 40 is an example of another apparatus that differs from television 50. Specifically, App server 40 controls an App that runs on terminal device 70 for viewing multiscreen broadcast. The App for viewing multiscreen broadcast is an example of a program for achieving the information providing method according to the present exemplary embodiment.

In the present exemplary embodiment, App server 40 previously receives the supplementary advertisement specifying information from broadcasting station 30, and manages the received supplementary advertisement specifying information. On receipt of the specifying information transmission instruction from broadcasting station 30, App server 40 transmits the supplementary advertisement specifying information to terminal device 70.

Television 50 is an example of a video receiving device that receives the video content and the first specifying information for specifying the supplementary information related to the video content via broadcast. In the present exemplary embodiment, television 50 receives the television CM and television CM ID transmitted by broadcast waves from broadcasting station 30. Television 50 displays the received television CM. Television 50 also transmits the received television CM ID to terminal device 70.

Wireless router 60 is a telecommunications apparatus that relays communications between different communication networks. Specifically, wireless router 60 connects, to communication network 15, television 50 and terminal device 70 to be connected by wireless communications. Alternatively, wireless router 60 may relay wireless communications between television 50 and terminal device 70.

Terminal device 70 is a terminal device that communicates with television 50, and is, for example, a portable information terminal, such as a cellular phone, smart phone, and tablet terminal. For example, the App for viewing multiscreen broadcast is previously installed in terminal device 70.

In the present exemplary embodiment, on receipt of the television CM ID from television 50, terminal device 70 transmits the received television CM ID to CM supplementary advertisement server 80. In addition, on receipt of the supplementary advertisement specifying information from App server 40, terminal device 70 transmits the received supplementary advertisement specifying information to CM supplementary advertisement server 80. That is, terminal device 70 transfers the television CM ID or supplementary advertisement specifying information to CM supplementary advertisement server 80.

Specifically, every time terminal device 70 receives the television CM ID or supplementary advertisement specifying information, terminal device 70 transmits the received television CM ID or supplementary advertisement specifying information together with a terminal ID to CM supplementary advertisement server 80. The terminal ID is an identifier unique to terminal device 70, and is, for example, a serial number. Terminal device 70 also receives and displays the CM supplementary advertisement transmitted from CM supplementary advertisement server 80.

CM supplementary advertisement server 80 is an example of a supplementary information server that provides supplementary information specified from among one or more pieces of supplementary information respectively related to one or more pieces of video content that may be broadcasted. CM supplementary advertisement server 80 associates and manages the CM supplementary advertisement transmitted from advertiser 20 with the television CM ID or the supplementary advertisement specifying information. On receipt of the specifying information (television CM ID or supplementary advertisement specifying information) from terminal device 70, CM supplementary advertisement server 80 transmits the CM supplementary advertisement specified using the received specifying information to terminal device 70.

Furthermore, CM supplementary advertisement server 80 includes a management unit that discriminates between the first specifying information and the second specifying information to manage frequency with which terminal device 70 receives the first specifying information (hereinafter referred to as “CM arrival frequency”). In the present exemplary embodiment, since the television CM ID (first specifying information) and the supplementary advertisement specifying information (second specifying information) are pieces of information different from each other, the management unit may easily discriminate between the first specifying information and the second specifying information.

Reception of the first specifying information by terminal device 70 means that terminal device 70 exists in a range in which terminal device 70 can communicate with television 50. That is, it may be said that the CM arrival frequency corresponds to frequency with which a user watches the television CM while the user who possesses terminal device 70 exists in a vicinity of television 50.

CM supplementary advertisement server 80 transmits the CM arrival frequency to advertiser 20. This allows advertiser 20 to grasp the frequency with which the user watches the television CM, and to perform processing for effective advertisement distribution (one example will be described in a fourth exemplary embodiment).

In second screen broadcast using television 50 and terminal device 70, information providing system 10 described above displays the CM supplementary advertisement related to a television CM on terminal device 70 in conjunction with the television CM. This allows the user to view the supplementary information on terminal device 70 in conjunction with the television broadcasting. In addition, advertiser 20 inquires of CM supplementary advertisement server 80 about users who watch an advertisement for advertiser 20 certain number of times, considers that these users are a user layer from which most significant advertising effect may be expected, and may perform effective advertisement distribution to the user layer.

### [1-1-2. Broadcasting Station (Video Transmitting Device)]

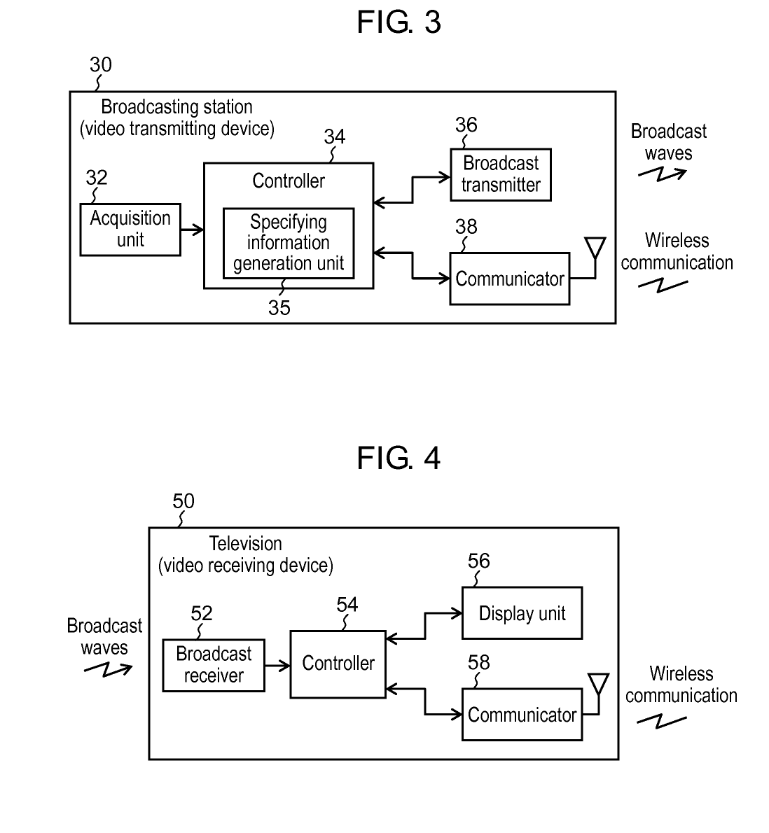

FIG. 3 is a block diagram illustrating a functional configuration of broadcasting station 30 according to the present exemplary embodiment. Broadcasting station 30 includes acquisition unit 32, controller 34, broadcast transmitter 36, and communicator 38.

Acquisition unit 32 acquires the television CM and television CM ID from advertiser 20. Acquisition unit 32 acquires, for example, the television CM and television CM ID from advertiser 20 via communicator 38 and communication network 15. Alternatively, acquisition unit 32 may acquire the television CM and television CM ID by reading the television CM and television CM ID from a recording medium that records the television CM and the television CM ID.

Controller 34 is a controller that controls each component that constitutes broadcasting station 30, and includes components such as a nonvolatile memory that stores a program, a nonvolatile memory that is a temporary storage area for executing the program, an input-output port, and a processor that executes the program. In the present exemplary embodiment, controller 34 includes specifying information generation unit 35.

Specifying information generation unit 35 generates the supplementary advertisement specifying information based on the television CM ID acquired by acquisition unit 32. The supplementary advertisement specifying information is information for specifying the CM supplementary advertisement. The supplementary advertisement specifying information, which may be identical to the television CM ID, is information different from the television CM ID in the present exemplary embodiment.

Controller 34 generates the specifying information transmission instruction, and transmits the specifying information transmission instruction at predetermined timing to App server 40 via communicator 38. For example, controller 34 transmits the specifying information transmission instruction at timing identical to timing when broadcast transmitter 36 transmits the television CM ID. Alternatively, controller 34 may receive a user operation for transmitting the specifying information transmission instruction, and may transmit the specifying information transmission instruction on receipt of the user operation.

Broadcast transmitter 36 broadcasts video content, such as a television CM and a television program. In the present exemplary embodiment, broadcast transmitter 36 further transmits the television CM ID at predetermined timing via broadcast. Specifically, the television CM ID is transmitted synchronizing with broadcast of the corresponding television CM. For example, broadcast transmitter 36 transmits the television CM ID simultaneously with broadcast start of the television CM ID.

Communicator 38 is a communication interface for communicating with App server 40 via communication network 15. In the present exemplary embodiment, communicator 38 previously transmits the supplementary advertisement specifying information generated by specifying information generation unit 35 to App server 40. Communicator 38 also transmits the specifying information transmission instruction to App server 40 based on control from controller 34. Communicator 38 may transmit the specifying information transmission instruction and the supplementary advertisement specifying information simultaneously.

### [1-1-3. Television (Video Receiving Device)]

FIG. 4 is a block diagram illustrating a functional configuration of television 50 according to the present exemplary embodiment. Television 50 includes broadcast receiver 52, controller 54, display unit 56, and communicator 58.

Broadcast receiver 52 receives broadcast waves transmitted from broadcasting station 30, and acquires data in which video of the television CM is encoded, the data being superimposed on the broadcast waves, and the television CM ID included in data broadcast, such as BML (Broadcast Markup Language).

Controller 54 is a controller that controls each component that constitutes television 50, and includes components such as a nonvolatile memory that stores a program, a nonvolatile memory that is a temporary storage area for executing the program, an input-output port, and a processor that executes the program. Controller 54 displays the video content acquired by broadcast receiver 52, such as the television CM, on display unit 56. Controller 54 also transmits the television CM ID acquired by broadcast receiver 52 to terminal device 70 via communicator 38.

Display unit 56 is a display-output device that includes a display component such as an LCD (Liquid Crystal Display). Display unit 56 displays the video content such as the television CM.

Communicator 58 is a communication interface that communicates with an apparatus connected to communication network 15 via wireless router 60, or terminal device 70. Communicator 58 may, for example, communicate with terminal device 70 directly. Communicator 58 performs wireless communications according to wireless-communications standards, such as Wi-Fi (registered trademark), Bluetooth (registered trademark), and ZigBee (registered trademark), for example. In the present exemplary embodiment, communicator 58 transmits the television CM ID acquired by broadcast receiver 52 to terminal device 70.

### [1-1-4. Terminal Device]

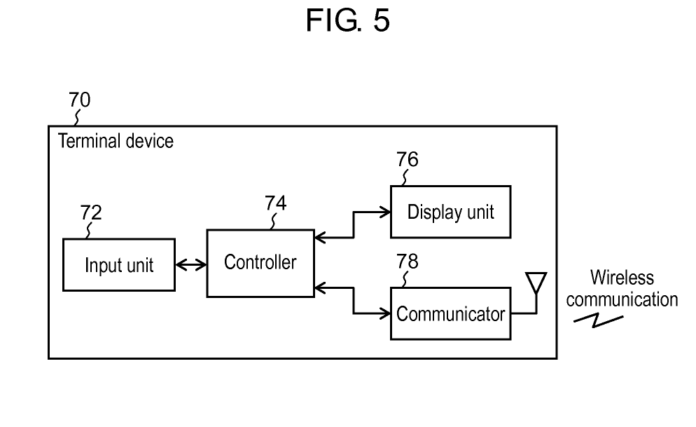

FIG. 5 is a block diagram illustrating a functional configuration of terminal device 70 according to the present exemplary embodiment. Terminal device 70 includes input unit 72, controller 74, display unit 76, and communicator 78.

Input unit 72 is an input device that receives user operation of a button, a touch panel, and the like.

Controller 74 is a controller that controls each component that constitutes terminal device 70, and includes components such as a nonvolatile memory that stores a program, a nonvolatile memory that is a temporary storage area for executing the program, an input-output port, and a processor that executes the program. Controller 74 executes, for example, App for viewing multiscreen broadcast.

In the present exemplary embodiment, controller 74 transmits the television CM ID or supplementary advertisement specifying information received by communicator 78 to CM supplementary advertisement server 80 via communicator 78. For example, controller 74 acquires the television CM ID from television 50 via communicator 78, and transmits the acquired television CM ID together with the terminal ID to CM supplementary advertisement server 80. Controller 74 also acquires the supplementary advertisement specifying information from App server 40 via communicator 78, and transmits the acquired supplementary advertisement specifying information together with the terminal ID to CM supplementary advertisement server 80. That is, controller 74 adds the terminal ID to the television CM ID and the supplementary advertisement specifying information, and transmits them to CM supplementary advertisement server 80.

Controller 74 further acquires the CM supplementary advertisement specified using the television CM ID or supplementary advertisement specifying information from CM supplementary advertisement server 80. Controller 74 displays the acquired CM supplementary advertisement on display unit 76.

Display unit 76 is a display-output device that includes a display component such as a liquid crystal display. Display unit 76 displays the CM supplementary advertisement acquired by controller 74.

Communicator 78 is a communication interface that communicates with an apparatus connected to communication network 15, or with television 50, via wireless router 60. Communicator 78 may, for example, communicate with television 50 directly. Communicator 78 performs wireless communications according to wireless-communications standards, such as Wi-Fi (registered trademark), Bluetooth (registered trademark), and ZigBee (registered trademark), for example.

In the present exemplary embodiment, communicator 78 receives the television CM ID from television 50, and receives the supplementary advertisement specifying information from App server 40. Communicator 78 also transmits the received television CM ID or supplementary advertisement specifying information together with the terminal ID to CM supplementary advertisement server 80. Communicator 78 also receives the CM supplementary advertisement transmitted from CM supplementary advertisement server 80, and outputs the CM supplementary advertisement to controller 74.

### [1-1-5. CM Supplementary Advertisement Server (Supplementary Information Server)]

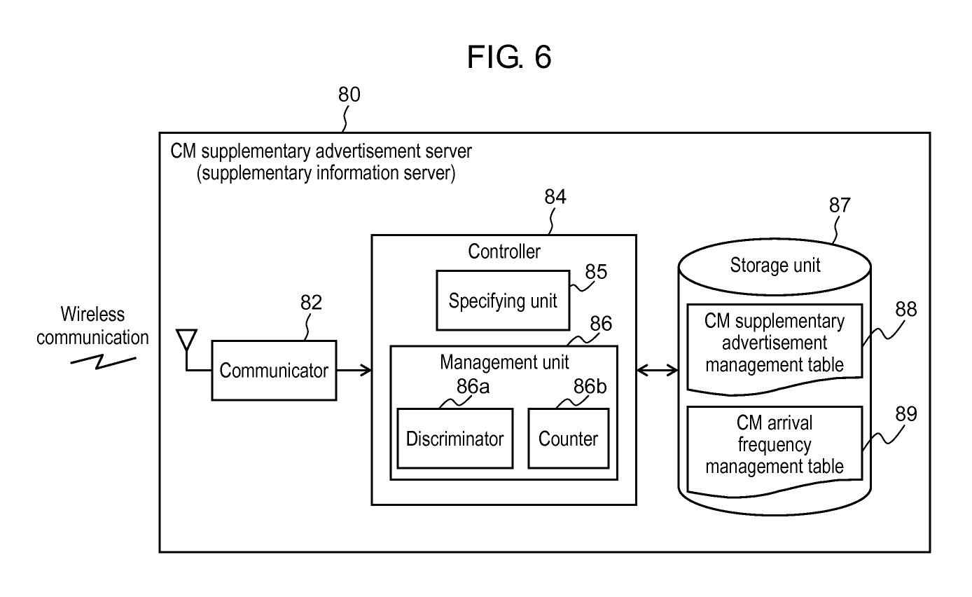

FIG. 6 is a block diagram illustrating a functional configuration of CM supplementary advertisement server 80 according to the present exemplary embodiment. CM supplementary advertisement server 80 includes communicator 82, controller 84, and storage unit 87.

Communicator 82 is a communication interface connected to communication network 15, communicating with terminal device 70 via wireless router 60. Communicator 82 performs communications according to communications standards, such as Wi-Fi (registered trademark) and Ethernet (registered trademark), for example.

Communicator 82 receives the specifying information and the terminal ID from terminal device 70 via communication network 15. The specifying information to receive is the television CM ID or the supplementary advertisement specifying information. It is unclear whether the specifying information is the television CM ID or the supplementary advertisement specifying information when communicator 82 receives the specifying information.

Communicator 82 also transmits the CM supplementary advertisement specified by controller 84 to terminal device 70 via communication network 15. Furthermore, in response to an inquiry from advertiser 20, communicator 82 transmits the CM arrival frequency managed by controller 84 to advertiser 20. Communicator 82 also receives the CM supplementary advertisement from advertiser 20.

Controller 84 is a controller that controls each component that constitutes CM supplementary advertisement server 80, and includes components such as a nonvolatile memory that stores a program, a nonvolatile memory that is a temporary storage area for executing the program, an input-output port, and a processor that executes the program. In the present exemplary embodiment, controller 84 includes specifying unit 85 and management unit 86.

Based on the specifying information received by communicator 82, specifying unit 85 refers to CM supplementary advertisement management table 88 stored in storage unit 87 to specify the CM supplementary advertisement.

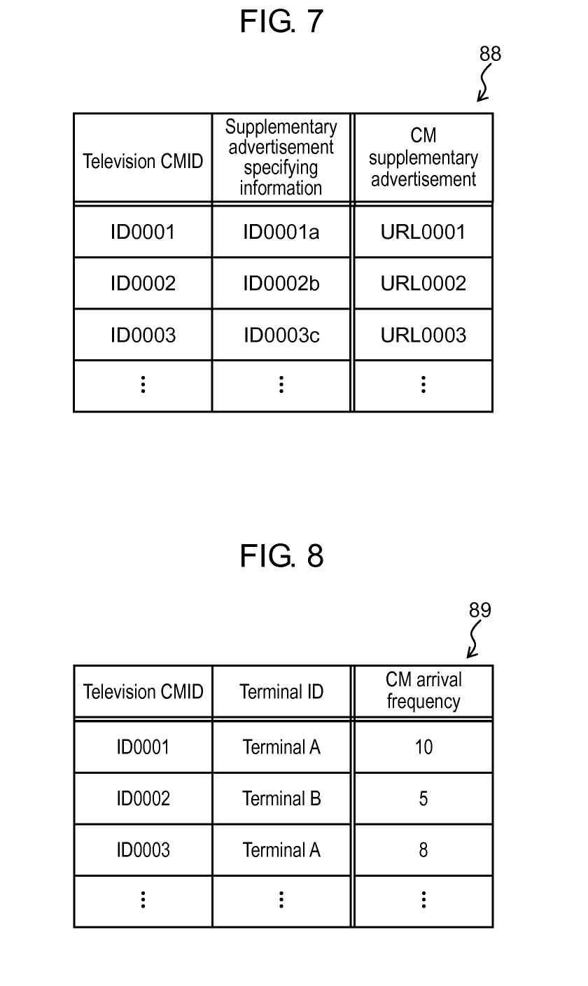

FIG. 7 is a diagram illustrating CM supplementary advertisement management table 88 according to the present exemplary embodiment.

As illustrated in FIG. 7, CM supplementary advertisement management table 88 associates the television CM ID and the supplementary advertisement specifying information with the CM supplementary advertisement. Specifically, as the CM supplementary advertisement, for example, CM supplementary advertisement management table 88 associates URL (Uniform Resource Locator) that indicates an actual file of the CM supplementary advertisement.

Specifying unit 85 acquires the CM supplementary advertisement corresponding to the specifying information received by communicator 82 with reference to CM supplementary advertisement management table 88. For example, specifying unit 85 compares the specifying information received by communicator 82 with the television CM ID and the supplementary advertisement specifying information in CM supplementary advertisement management table 88, to search for the television CM ID or supplementary advertisement specifying information that coincides with the specifying information received by communicator 82. Specifying unit 85 then acquires the CM supplementary advertisement associated with the television CM ID or supplementary advertisement specifying information that coincides with the specifying information received by communicator 82, and transmits the acquired CM supplementary advertisement to terminal device 70 via communicator 82. Accordingly, the CM supplementary advertisement is displayed on display unit 76 of terminal device 70.

On receipt of the specifying information, specifying unit 85 determines whether a predetermined period of time has elapsed after transmission of the CM supplementary advertisement specified using the specifying information received before, and broadcasts the CM supplementary advertisement again only when the predetermined period of time has elapsed. In other simple words, on receipt of a plurality of pieces of specifying information corresponding to the identical CM supplementary advertisement during a short period of time, specifying unit 85 transmits the CM supplementary advertisement only once. Accordingly, when the television CM ID is transmitted from App server 40 to terminal device 70 by communications and the identical television CM ID is simultaneously transmitted from television 50 to terminal device 70 via broadcast, terminal device 70 may inhibit excessive display of identical CM supplementary advertisement on terminal device 70 by acquiring the CM supplementary advertisement for each of the television CM ID received from App server 40 and the identical television CM ID received from television 50. Note that the predetermined period of time is, for example, a period shorter than a length of one television CM, and is a period of time equal to or shorter than 15 seconds as an example.

Management unit 86 discriminates between the television CM ID and the supplementary advertisement specifying information, and manages the frequency with which terminal device 70 receives the television CM ID. As illustrated in FIG. 6, management unit 86 includes discriminator 86a and counter 86b.

Discriminator 86a discriminates between the television CM ID and the supplementary advertisement specifying information. In the present exemplary embodiment, the television CM ID and the supplementary advertisement specifying information are pieces of information different from each other. Therefore, for example, discriminator 86a compares the specifying information received by communicator 82 with the television CM ID or supplementary advertisement specifying information in CM supplementary advertisement management table 88, to determine which specifying information of the television CM ID and supplementary advertisement specifying information communicator 82 receives.

For example, when the specifying information received by communicator 82 coincides with either of the television CM ID managed in CM supplementary advertisement management table 88, discriminator 86a may determine that the specifying information received by communicator 82 is the television CM ID. When the specifying information received by communicator 82 coincides with either of the supplementary advertisement specifying information managed in CM supplementary advertisement management table 88, discriminator 86a may determine that the specifying information received by communicator 82 is the supplementary advertisement specifying information. Since this discrimination processing is identical to search processing performed by specifying unit 85, only either processing may be performed.

For example, when the format differs between the television CM ID and the supplementary advertisement specifying information, specifying unit 85 may discriminate the format of the received specifying information. For example, when a number of bits differs between the television CM ID and the supplementary advertisement specifying information, specifying unit 85 may discriminate the number of bits, and may easily discriminate between the television CM ID and the supplementary advertisement specifying information.

Counter 86b counts the frequency with which terminal device 70 receives the television CM ID (CM arrival frequency), based on a determination result by discriminator 86a. In the present exemplary embodiment, when it is determined that the specifying information received by communicator 82 is the television CM ID, counter 86b increments the CM arrival frequency corresponding to the television CM ID and the terminal ID transmitted together with the television CM ID.

The CM arrival frequency is managed in CM arrival frequency management table 89 stored in storage unit 87. FIG. 8 is a diagram illustrating CM arrival frequency management table 89 according to the present exemplary embodiment.

As illustrated in FIG. 8, CM arrival frequency management table 89 associates and manages the CM arrival frequency with a combination of the television CM ID and the terminal ID. That is, in the present exemplary embodiment, management unit 86 manages the CM arrival frequency for each television CM ID and each terminal device. In other words, management unit 86 manages the CM arrival frequency for each television CM and each terminal device. For example, a record in a first line of FIG. 8 means that a user of “terminal A” has watched the television CM corresponding to “ID0001” “10 times”.

With the above configuration, every time communicator 82 receives the specifying information, management unit 86 discriminates whether the received specifying information is the television CM ID. When the received specifying information is the television CM ID, management unit 86 counts and manages the CM arrival frequency corresponding to the television CM ID and the terminal ID transmitted together with the television CM ID.

Storage unit 87 is a storage device that holds CM supplementary advertisement management table 88 and CM arrival frequency management table 89. Storage unit 87 is, for example, a HDD (Hard Disk Drive) or a semiconductor memory, such as a flash memory.

### [1-2. Operation]

Next, an operation of information providing system 10 configured as described above according to the present exemplary embodiment, that is, the information providing method will be described.

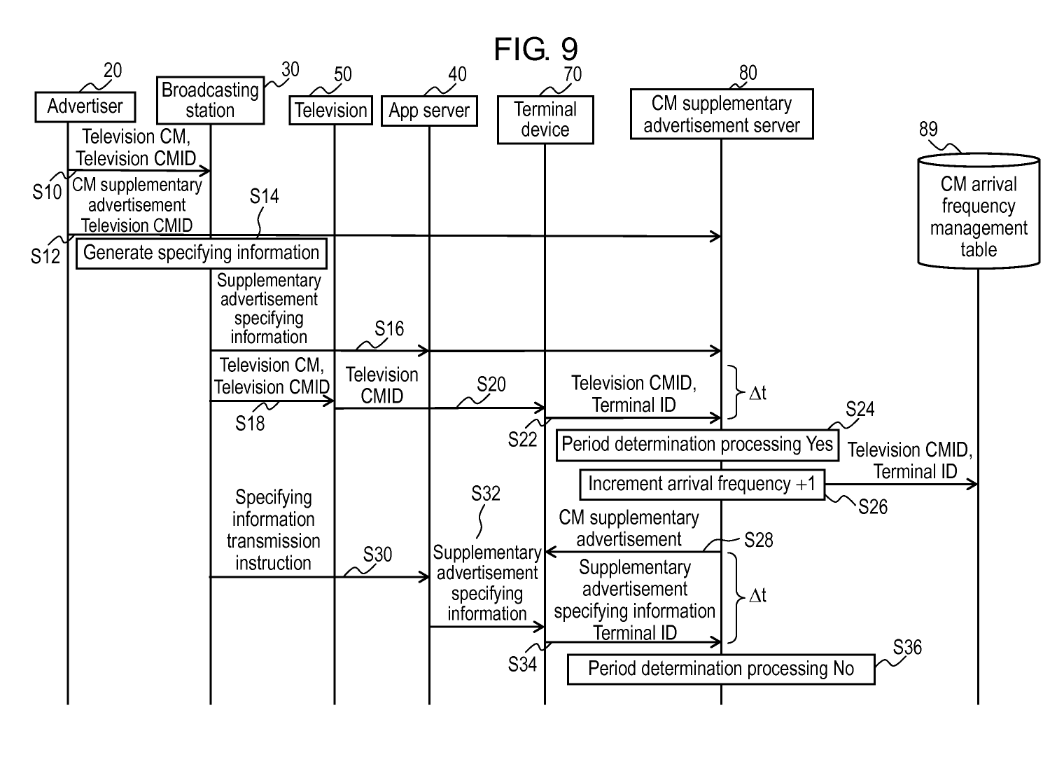

FIG. 9 is a sequence diagram illustrating the operation of information providing system 10 according to the present exemplary embodiment.

First, advertiser 20 creates a television CM and transmits the created television CM and a television CM ID allocated to the television CM to broadcasting station 30 (S10). Next, advertiser 20 creates a CM supplementary advertisement that supplements the television CM, and transmits the created CM supplementary advertisement and the television CM ID to CM supplementary advertisement server 80 (S12). Either one of step S10 and step S12 may be performed first. Although unillustrated, CM supplementary advertisement server 80 associates the CM supplementary advertisement with the television CM ID acquired from advertiser 20, and manages the CM supplementary advertisement and the television CM ID in CM supplementary advertisement management table 88.

Next, broadcasting station 30 generates supplementary advertisement specifying information corresponding to the received television CM and the television CM ID (S14). Broadcasting station 30 then transmits the generated supplementary advertisement specifying information to App server 40 and CM supplementary advertisement server 80 (S16). Although unillustrated, CM supplementary advertisement server 80 associates the received supplementary advertisement specifying information with the television CM ID, and manages the received supplementary advertisement specifying information and the television CM ID in CM supplementary advertisement management table 88.

Processing described above from step S10 to step S16 is previously performed as pre-processing, before the television CM is actually broadcasted. Transmission of the supplementary advertisement specifying information in step S16 may be performed simultaneously with transmission of the specifying information transmission instruction to be described later (S30).

Next, broadcasting station 30 transmits the television CM and the television CM ID by broadcast (S18). Television 50 receives the broadcasted television CM and the television CM ID, and transmits the television CM ID to terminal device 70 while displaying the television CM on display unit 56 (S20).

Terminal device 70 receives the television CM ID, and transmits the received television CM ID together with the terminal ID to CM supplementary advertisement server 80 (S22). In CM supplementary advertisement server 80, specifying unit 85 performs period determination processing (S24). Specifically, specifying unit 85 determines whether a predetermined period of time (Δt) has elapsed after transmission of the CM supplementary advertisement specified using the television CM ID or supplementary advertisement specifying information received before.

If the predetermined period of time has elapsed (Yes in S24), discriminator 86a discriminates whether the received specifying information is the television CM ID (first specifying information). Since the received specifying information is the television CM ID here, counter 86b increments the CM arrival frequency corresponding to the television CM ID and the terminal ID received together with the television CM ID, with reference to CM arrival frequency management table 89 (S26).

Specifying unit 85 then transmits the CM supplementary advertisement specified by the received television CM ID to terminal device 70 (S28).

Meanwhile, broadcasting station 30 transmits the specifying information transmission instruction to App server 40 (S30). Step S30 may be performed, for example, simultaneously with transmission of the television CM ID (S18).

App server 40 transmits the supplementary advertisement specifying information to terminal device 70 with receipt of the specifying information transmission instruction as an impetus (S32). The transmitted supplementary advertisement specifying information is received by terminal device 70 via communication network 15 and wireless router 60.

Terminal device 70 receives the supplementary advertisement specifying information, and transmits the received supplementary advertisement specifying information together with the terminal ID to CM supplementary advertisement server 80 (S34). In CM supplementary advertisement server 80, specifying unit 85 performs period determination processing (S36).

As a result, if the predetermined period of time (Δt) has not elapsed (No in S36), in order to prevent excessive display of the CM supplementary advertisement, controller 84 stops specifying of the CM supplementary advertisement. Therefore, the CM supplementary advertisement is not transmitted to terminal device 70, and is not displayed on display unit 76.

For example, even if broadcasting station 30 performs transmission of the television CM ID (S18) and transmission of the specifying information transmission instruction (S30) simultaneously, the supplementary advertisement specifying information that travels through App server 40 and communication network 15 may reach terminal device 70 slightly later than the television CM ID that travels through television 50. Therefore, the period determination processing performed by specifying unit 85 may inhibit that two CM supplementary advertisements are displayed on display unit 76 of terminal device 70 during a short period.

FIG. 9 illustrates an example of determination that, at a time of receiving the supplementary advertisement specifying information, the predetermined period of time has not elapsed. However, it may also be determined that, at a time of receiving the television CM ID, the predetermined period of time has not elapsed. In this case, counter 86b may prohibit incrementing the CM arrival frequency. The predetermined period of time having not elapsed means that, for example, if the predetermined period of time is a length of one television CM (for example, 15 seconds), a plurality of pieces of specifying information is received during broadcast of one television CM. Therefore, even if a plurality of television CM IDs is received, the user watches one television CM only once.

### [1-3. Summary]

As described above, in information providing system 10 according to the present exemplary embodiment, terminal device 70 receives the specifying information for specifying the CM supplementary advertisement from either of television 50 and App server 40. Terminal device 70 transfers the received specifying information to CM supplementary advertisement server 80.

Thus, in a second screen broadcast system that allows viewing of the supplementary information (CM supplementary advertisement) with terminal device 70 in conjunction with television broadcast, there are two paths for receiving the specifying information. That is, (i) receiving the specifying information transmitted by broadcast from television 50 (via television), and (ii) receiving the specifying information transmitted synchronizing with broadcast from App server 40 via communication network 15 (via network). Depending on the system, both of the paths may be used, and only either one path may be used (for example, via network).

At this time, if terminal device 70 may be connected to the Internet (communication network 15), terminal device 70 may receive the specifying information via App server 40. That is, even when the user is distant from television 50 and is not watching the television CM, terminal device 70 may receive the specifying information, and the television CM is not necessarily watched by the user.

Therefore, CM supplementary advertisement server 80 needs to grasp via which path the specifying information is received by terminal device 70. However, in a conventional system, CM supplementary advertisement server 80 may not know via which path terminal device 70 receives the specifying information.

Therefore, information providing system 10 according to the present exemplary embodiment is an information providing system that provides a CM supplementary advertisement related to a television CM in parallel with broadcast of the television CM. Information providing system 10 includes CM supplementary advertisement server 80 that provides the CM supplementary advertisement specified from among one or more CM supplementary advertisements respectively related to one or more television CMs that may be broadcast, television 50 that receives via broadcast the television CM and a television CM ID (first specifying information) for specifying the CM supplementary advertisement related to the television CM, and terminal device 70. On receipt of the television CM ID from television 50, terminal device 70 transmits the television CM ID to CM supplementary advertisement server 80, and on receipt of the supplementary advertisement specifying information (second specifying information) for specifying the CM supplementary advertisement from App server 40 different from television 50, terminal device 70 transmits supplementary advertisement specifying information to CM supplementary advertisement server 80. CM supplementary advertisement server 80 transmits, to terminal device 70, the CM supplementary advertisement specified using the television CM ID or supplementary advertisement specifying information received from terminal device 70. Information providing system 10 further includes management unit 86 that discriminates between the television CM ID and the supplementary advertisement specifying information, to manage the frequency with which terminal device 70 receives the television CM ID.

Accordingly, information providing system 10 discriminates between the first specifying information and the second specifying information, and manages the frequency with which terminal device 70 receives the first specifying information, and thus may accurately manage the frequency with which broadcasted video content (television CM) is watched by the user. Therefore, the present exemplary embodiment allows information providing system 10 to effectively provide information, such as advertisement distribution.

For example, in the present exemplary embodiment, the television CM ID (first specifying information) and the supplementary advertisement specifying information (second specifying information) specify identical supplementary information and are different from each other.

This allows information providing system 10 to discriminate between the first specifying information and the second specifying information easily, and to accurately manage the CM arrival frequency. For example, using the television CM ID as the first specifying information and using the supplementary information specifying information generated based on the television CM ID as the second specifying information allow easy discrimination between the first specifying information and the second specifying information.

For example, in the present exemplary embodiment, management unit 86 manages the CM arrival frequency for each television CM and each terminal device.

Since the CM arrival frequency is managed for each television CM and each terminal accordingly, information may be provided more effectively. For example, it is possible to manage which television CM a user of which terminal watches how many times. Therefore, it is possible to determine what kind of advertisement is to be distributed to each user, thereby enhancing advertising effects and reducing unnecessary advertising expenses.

For example, in the present exemplary embodiment, on receipt of the television CM ID or supplementary advertisement specifying information, CM supplementary advertisement server 80 determines whether a predetermined period of time has elapsed after transmission of the CM supplementary advertisement specified using the television CM ID or supplementary advertisement specifying information received before, and broadcasts the CM supplementary advertisement again only when the predetermined period of time has elapsed.

This may inhibit the CM supplementary advertisement from being displayed on terminal device 70 twice or more during a short period. That is, this may inhibit one CM supplementary advertisement from being displayed frequently, and may inhibit a user from being bored.

For example, in the present exemplary embodiment, the video content is a commercial message (television CM), and the supplementary information is advertisement supplementary information that indicates information on the commercial message in detail (CM supplementary advertisement).

This allows terminal device 70 to display information the television CM is unable to convey sufficiently as the CM supplementary advertisement in conjunction with the television CM. For example, displaying information such as how to use a product the television CM advertises and URL of a source of purchase improves user convenience and achieves sales promotion of the product.

Therefore, an information providing method according to the present exemplary embodiment is an information providing method for providing a CM supplementary advertisement related to a television CM in parallel with broadcast of the television CM. The information providing method includes: receiving via broadcast, by television 50, the television CM and a television CM ID for specifying the CM supplementary advertisement related to the television CM; transmitting, by terminal device 70, the television CM ID to CM supplementary advertisement server 80 on receipt of the television CM ID from television 50, and transmitting supplementary advertisement specifying information to CM supplementary advertisement server 80 on receipt of the supplementary advertisement specifying information for specifying the CM supplementary advertisement from App server 40; transmitting to terminal device 70, by CM supplementary advertisement server 80, the CM supplementary advertisement specified using the television CM ID or supplementary advertisement specifying information received from terminal device 70 from among one or more CM supplementary advertisements respectively related to one or more television CMs that may be broadcasted; and discriminating, by management unit 86, between the television CM ID and the supplementary advertisement specifying information, and managing frequency with which terminal device 70 receives the television CM ID.

Since this discriminates between the first specifying information and the second specifying information, and manages the frequency with which terminal device 70 receives the first specifying information, the frequency with which a user watches broadcasted video content (television CM) may be managed accurately. Therefore, the present exemplary embodiment allows information providing system 10 to effectively provide information, such as advertisement distribution.

These comprehensive or specific aspects may be implemented as a system, a device, an integrated circuit, a computer program, a computer-readable storage medium such as a CD-ROM, or any selective combination thereof.

### Second Exemplary Embodiment

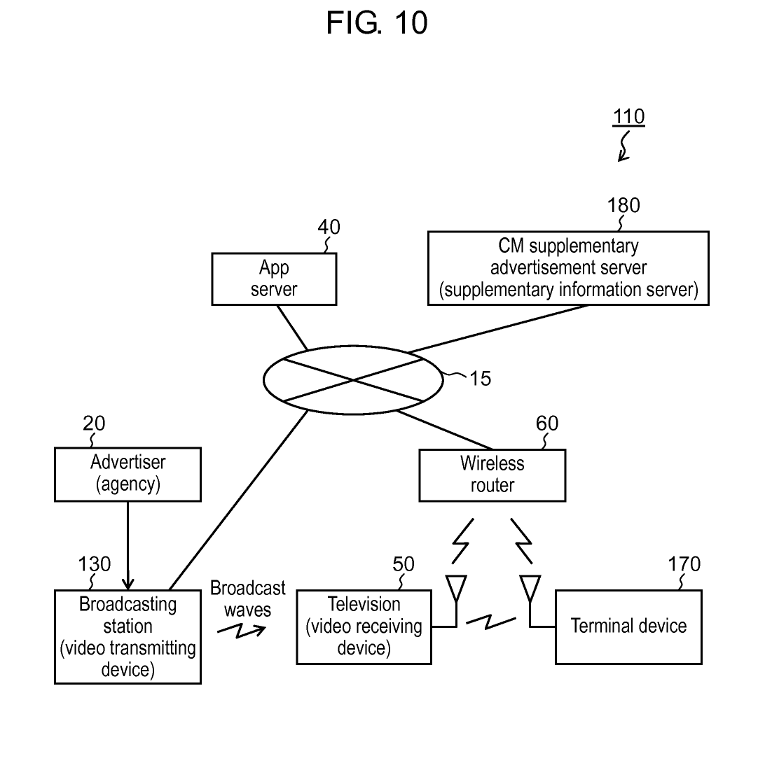

Next, an information providing system and information providing method according to a second exemplary embodiment will be described with reference to FIG. 10 to FIG. 16.

### [2-1. Configuration]

### [2-1-1. Overall System Configuration]

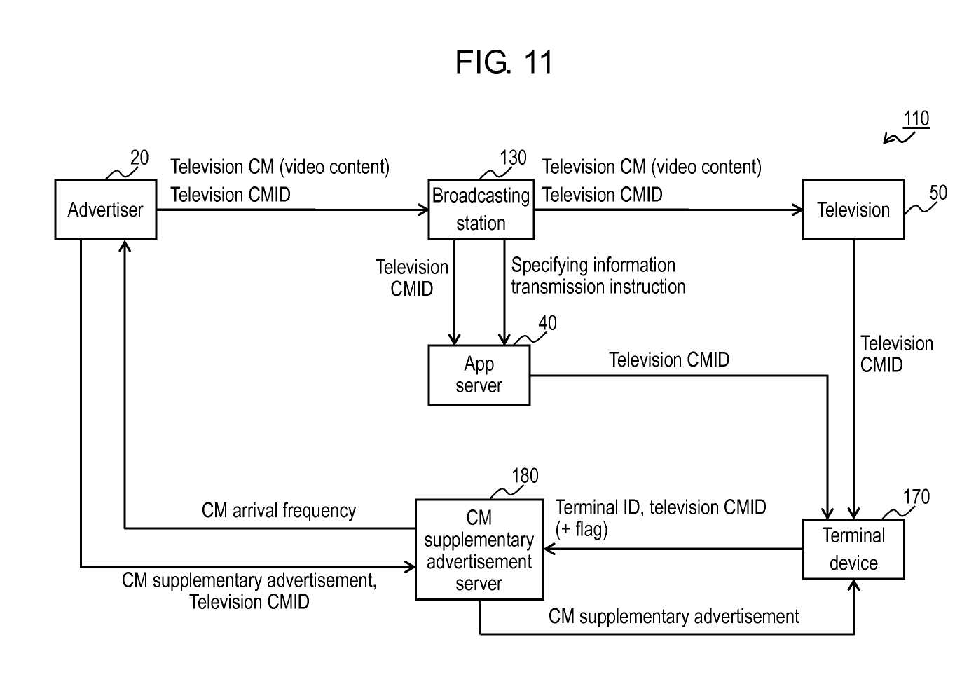

FIG. 10 is a diagram illustrating a configuration of information providing system 110 according to the present exemplary embodiment. FIG. 11 is a diagram illustrating a flow of information in information providing system 110 according to the present exemplary embodiment.

The first exemplary embodiment has described an example using pieces of information different from each other, first specifying information via television and second specifying information via an App server (communication network). In the present exemplary embodiment, the first specifying information and the second specifying information are identical information. Information providing system 110 according to the present exemplary embodiment includes an imparter that imparts identification information for identifying the first specifying information and the second specifying information to either one of the first specifying information and the second specifying information.

As illustrated in FIG. 10, information providing system 110 differs from information providing system 10 according to the first exemplary embodiment in that information providing system 110 includes broadcasting station 130, terminal device 170, and CM supplementary advertisement server 180 instead of broadcasting station 30, terminal device 70, and CM supplementary advertisement server 80. The following description focuses on differences from the first exemplary embodiment.

Broadcasting station 130 does not generate supplementary advertisement specifying information, but as illustrated in FIG. 11, transmits a television CM ID to App server 40 as the second specifying information. That is, in the present exemplary embodiment, the first specifying information and the second specifying information are identical information, and specifically, the television CM ID is used.

Terminal device 170 receives the television CM ID from television 50, and receives the television CM ID also from App server 40, then transmits the received television CM ID to CM supplementary advertisement server 80. In the present exemplary embodiment, terminal device 170 imparts the identification information to the television CM ID received from television 50, and transmits the television CM ID and the identification information to CM supplementary advertisement server 80.

The identification information is flag information that indicates that terminal device 170 has received the first specifying information. That is, the identification information is the flag information that indicates that terminal device 170 has received the television CM ID from television 50. In other words, the television CM ID to which the flag information is imparted is the specifying information transmitted via television 50.

CM supplementary advertisement server 180 is identical to CM supplementary advertisement server 80 according to the first exemplary embodiment, except for a different method for discriminating the received specifying information. In the present exemplary embodiment, CM supplementary advertisement server 180 discriminates which of the first specifying information and the second specifying information the received specifying information is, by acquiring the identification information imparted to the received specifying information (television CM ID).

### [2-1-2. Broadcasting Station (Video Transmitting Device)]

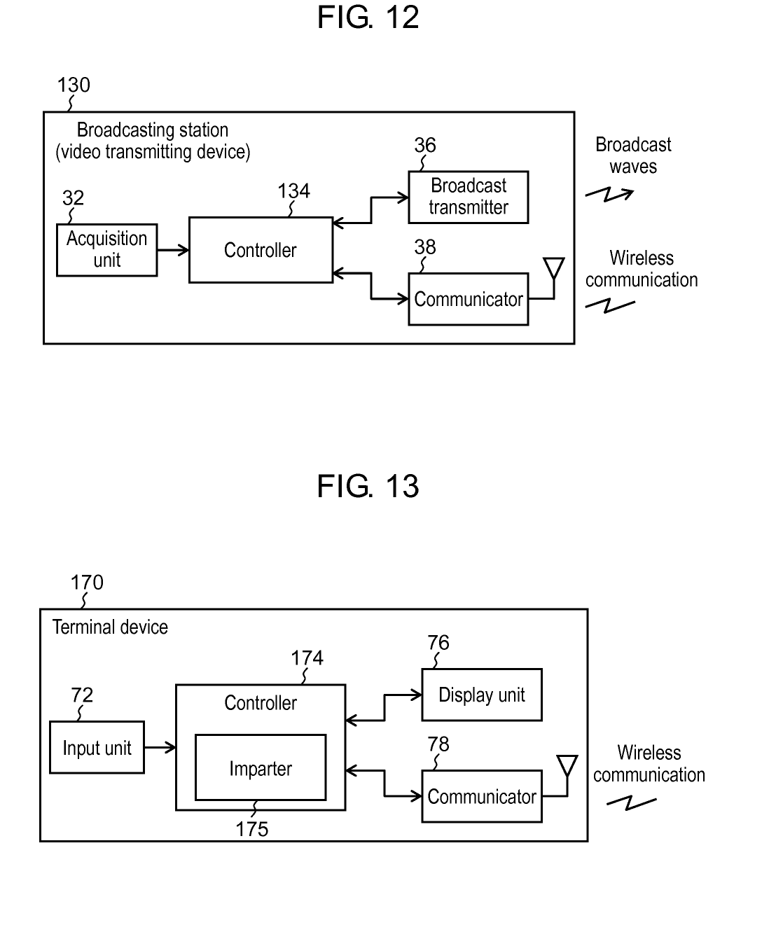

FIG. 12 is a block diagram illustrating a functional configuration of broadcasting station 130 according to the present exemplary embodiment. Broadcasting station 130 differs from broadcasting station 30 according to the first exemplary embodiment illustrated in FIG. 3 in that broadcasting station 130 includes controller 134 instead of controller 34.

Like controller 34, controller 134 is a controller that controls each component that constitutes broadcasting station 130. Controller 134 does not include specifying information generation unit 35. That is, controller 134 transmits, via communicator 38 to App server 40, the television CM ID acquired by acquisition unit 32 as the second specifying information.

As described above, broadcasting station 30 transmits the television CM ID to each of television 50 and App server 40 as the specifying information.

### [2-1-3. Terminal Device]

FIG. 13 is a block diagram illustrating a functional configuration of terminal device 170 according to the present exemplary embodiment. Terminal device 170 differs from terminal device 70 according to the first exemplary embodiment illustrated in FIG. 5 in that terminal device 170 includes controller 174 instead of controller 74.

Like controller 74, controller 174 is a controller that controls each component that constitutes terminal device 170. Controller 174 includes imparter 175.

Imparter 175 imparts the identification information for identifying the first specifying information and the second specifying information to either one of the first specifying information and the second specifying information. In the present exemplary embodiment, imparter 175 imparts the flag information (identification information) to the first specifying information, that is, the television CM ID received from television 50. Accordingly, controller 174 transmits, via communicator 78, the first specifying information to which the flag information is imparted (that is, the television CM ID via television 50).

Imparter 175 does not impart the flag information to the second specifying information. That is, imparter 175 does not impart the flag information to the television CM ID received via communication network 15 from App server 40. Accordingly, controller 174 transmits, via communicator 78, the second specifying information to which the flag information is not imparted (that is, the television CM ID via App server 40).

For example, based on information received accompanying the received television CM ID (for example, information indicating a transmitting source), imparter 175 determines whether the received television CM ID is the first specifying information or the second specifying information. Imparter 175 then determines whether to impart the flag information based on a determination result.

The flag information is information that indicates that terminal device 170 has received the television CM ID from television 50, and for example, is expressed in one bit. Imparting the flag information means setting a value of the one bit at “1”, whereas not imparting the flag information means setting the value of the one bit at “0”. These setting values may be opposite. That is, imparter 175 may impart the flag information to the second specifying information, and may not impart the flag information to the first specifying information.

### [2-1-4. CM Supplementary Advertisement Server (Supplementary Information Server)]

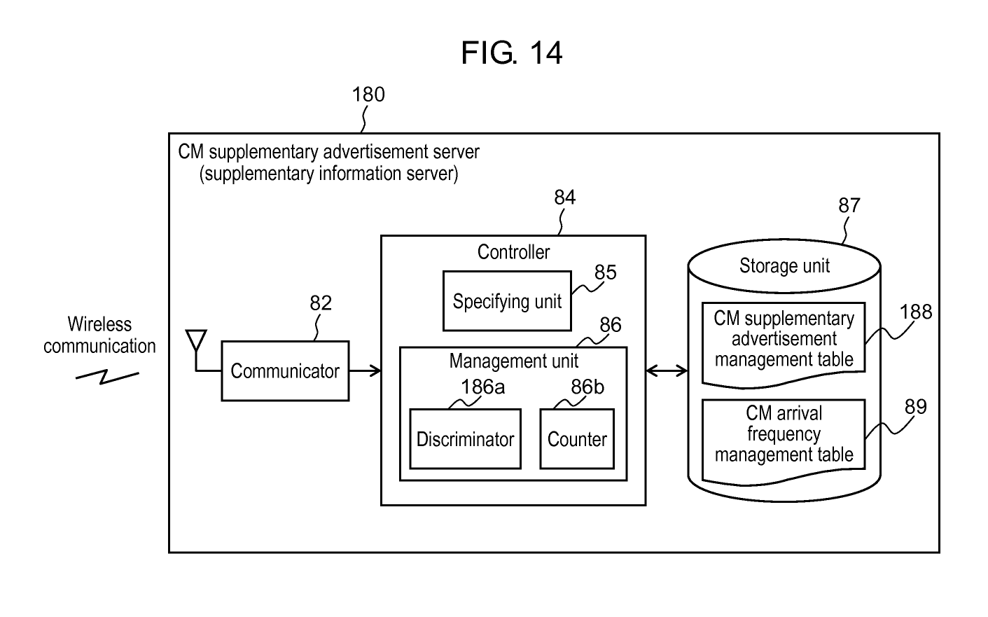

FIG. 14 is a block diagram illustrating a functional configuration of CM supplementary advertisement server 180 according to the present exemplary embodiment. CM supplementary advertisement server 180 differs from CM supplementary advertisement server 80 according to the first exemplary embodiment illustrated in FIG. 6 in that management unit 86 includes discriminator 186a instead of discriminator 86a, and that storage unit 87 stores CM supplementary advertisement management table 188 instead of CM supplementary advertisement management table 88.

Discriminator 186a discriminates between the first specifying information and the second specifying information by acquiring the identification information. Specifically, discriminator 186a determines whether the flag information is imparted to the specifying information acquired by communicator 82. If the flag information is imparted, the specifying information acquired by communicator 82 is the first specifying information terminal device 170 receives from television 50. If the flag information is not imparted, the specifying information acquired by communicator 82 is the second specifying information terminal device 170 receives from App server 40.

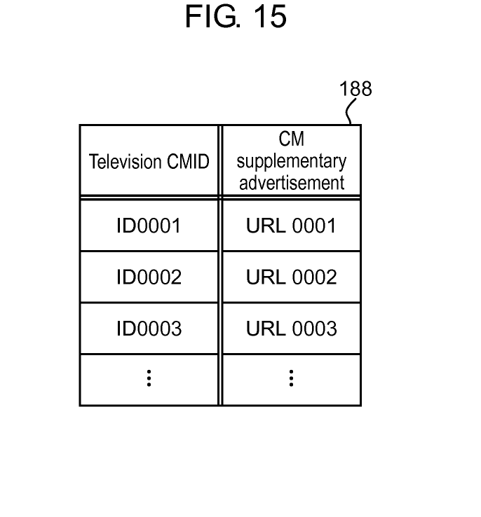

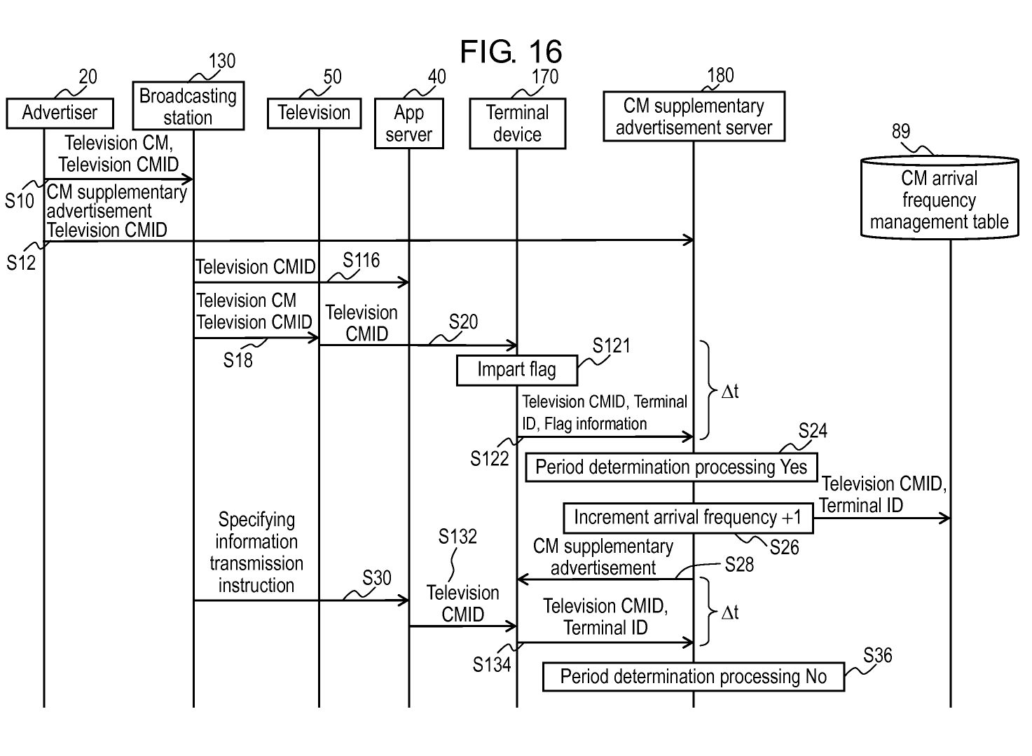

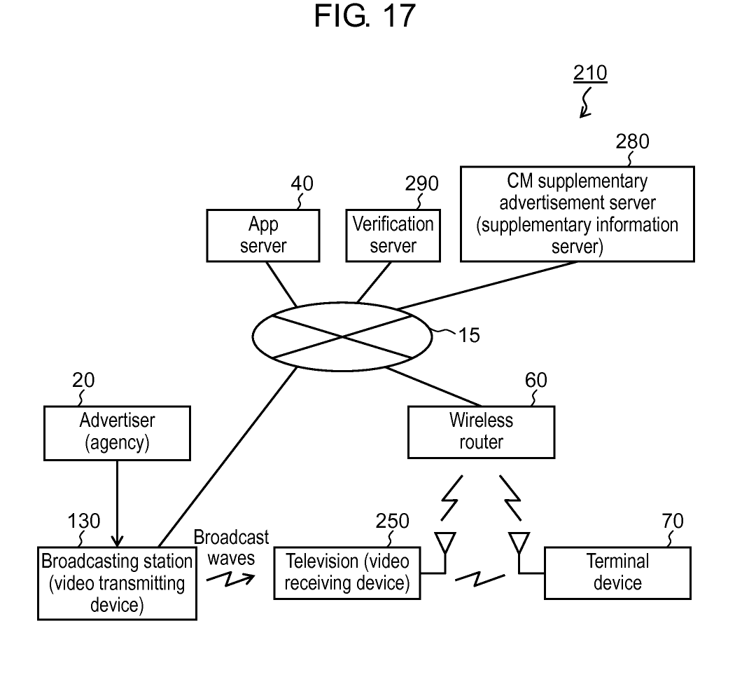

In the present exemplary embodiment, the first specifying information and the second specifying information are identical information, and specifically, are the television CM ID. Therefore, in the present exemplary embodiment, as illustrated in FIG. 15, CM supplementary advertisement management table 188 associates the television CM ID with the CM supplementary advertisement. FIG. 15 is a diagram illustrating CM supplementary advertisement management table 188 according to the present exemplary embodiment.

Based on the television CM ID acquired by communicator 82, specifying unit 85 acquires the CM supplementary advertisement corresponding to the television CM ID with reference to CM supplementary advertisement management table 188. Specific processing is identical to the processing in the first exemplary embodiment.

### [2-2. Operation]

Next, an operation of information providing system 110 configured as described above according to the present exemplary embodiment, that is, the information providing method will be described.

FIG. 16 is a sequence diagram illustrating the operation of information providing system 110 according to the present exemplary embodiment.

First, advertiser 20 transmits a television CM and the television CM ID to broadcasting station 130 (S10), and transmits the CM supplementary advertisement and the television CM ID to CM supplementary advertisement server 180 (S12). This transmission processing is identical to the processing in the first exemplary embodiment. Broadcasting station 130 may transmit the CM supplementary advertisement and the television CM ID to CM supplementary advertisement server 180.

Next, broadcasting station 130 transmits the received television CM ID to App server 40 (S116). That is, since the present exemplary embodiment uses the television CM ID, which is information identical to the first specifying information, as the second specifying information, broadcasting station 130 transfers the television CM ID to App server 40.

Processing described above from step S10 to step S116 is previously performed as pre-processing, before the television CM is actually broadcasted. Transmission of the television CM ID in step S116 may be performed simultaneously with transmission of the specifying information transmission instruction (S30).

Next, broadcasting station 130 transmits, by broadcast, the television CM and the television CM ID (S18). Television 50 receives the broadcasted television CM and the television CM ID, and transmits the television CM ID to terminal device 170 (S20) while displaying the television CM on display unit 56.

In terminal device 170, imparter 175 imparts the flag information to the received television CM ID (S121). Terminal device 170 then transmits the television CM ID, to which the flag information is imparted, together with the terminal ID to CM supplementary advertisement server 180 (S122).

In CM supplementary advertisement server 180, specifying unit 85 performs period determination processing (S24). Details of the period determination processing are similar to the period determination processing in the first exemplary embodiment. If a predetermined period of time (Δt) has elapsed after transmission of an identical CM supplementary advertisement (Yes in S24), discriminator 186a discriminates the television CM ID by determining whether the flag information is imparted. Counter 86b increments CM arrival frequency corresponding to the television CM ID and the terminal ID received together with the television CM ID, with reference to CM arrival frequency management table 89 (S26).

Specifying unit 85 then transmits the CM supplementary advertisement specified by the received television CM ID to terminal device 170 (S28).

Meanwhile, broadcasting station 30 transmits the specifying information transmission instruction to App server 40 (S30). Step S30 may be performed, for example, simultaneously with transmission of the television CM ID (S18).

App server 40 transmits the television CM ID to terminal device 170 with receipt of the specifying information transmission instruction as an impetus (S132). The transmitted television CM ID is received by terminal device 170 via communication network 15 and wireless router 60.

Terminal device 170 receives the television CM ID, and transmits the received television CM ID together with the terminal ID to CM supplementary advertisement server 180 (S134). At this time, since terminal device 170 receives the television CM ID from App server 40, imparter 175 does not impart the flag information to the television CM ID. That is, terminal device 170 transmits only the television CM ID and the terminal ID, without transmitting the flag information.

In CM supplementary advertisement server 180, specifying unit 85 performs period determination processing (S36). Subsequent processing is similar to the processing in the first exemplary embodiment.

### [2-3. Summary]

As described above, in information providing system 110 according to the present exemplary embodiment, the first specifying information and the second specifying information are identical information, information providing system 110 further includes imparter 175 that imparts identification information for identifying the first specifying information and the second specifying information to either one of the first specifying information and the second specifying information, and management unit 86 includes discriminator 86a that discriminates between the first specifying information and the second specifying information by acquiring the identification information, and counter 86b that counts CM arrival frequency based on a discrimination result by discriminator 86a.

Accordingly, using the identification information allows easy discrimination between the first specifying information and the second specifying information. Therefore, for example, this allows reduction of an amount of processing involved in the discrimination, and thus allows reduction of power consumption.

For example, in the present exemplary embodiment, the identification information is the flag information that indicates that terminal device 170 has received the television CM ID. Imparter 175 imparts the identification information to the television CM ID, and terminal device 170 includes imparter 175.

Since terminal device 170 imparts the flag information accordingly, the first specifying information and the second specifying information may be discriminated accurately.

For example, in the present exemplary embodiment, CM supplementary advertisement server 180 includes management unit 86, and terminal device 170 transmits the television CM ID, to which the identification information is imparted, to CM supplementary advertisement server 180.

This allows CM supplementary advertisement server 180 to manage the CM arrival frequency, which facilitates processing with regard to advertisement distribution, such as notification of the CM arrival frequency to advertiser 20, and management of the CM arrival frequency to users of another terminal device 170. Therefore, the present exemplary embodiment allows information providing system 110 to effectively provide information, such as advertisement distribution.

The present exemplary embodiment has described the configuration in which terminal device 170 includes imparter 175, but the configuration is not limited to this example. For example, either one of broadcasting station 130, television 50, and App server 40 may include imparter 175.

### Third Exemplary Embodiment

Next, an information providing system and information providing method according to a third exemplary embodiment will be described with reference to FIG. 17 to FIG. 21.

### [3-1. Configuration]

### [3-1-1. Overall System Configuration]

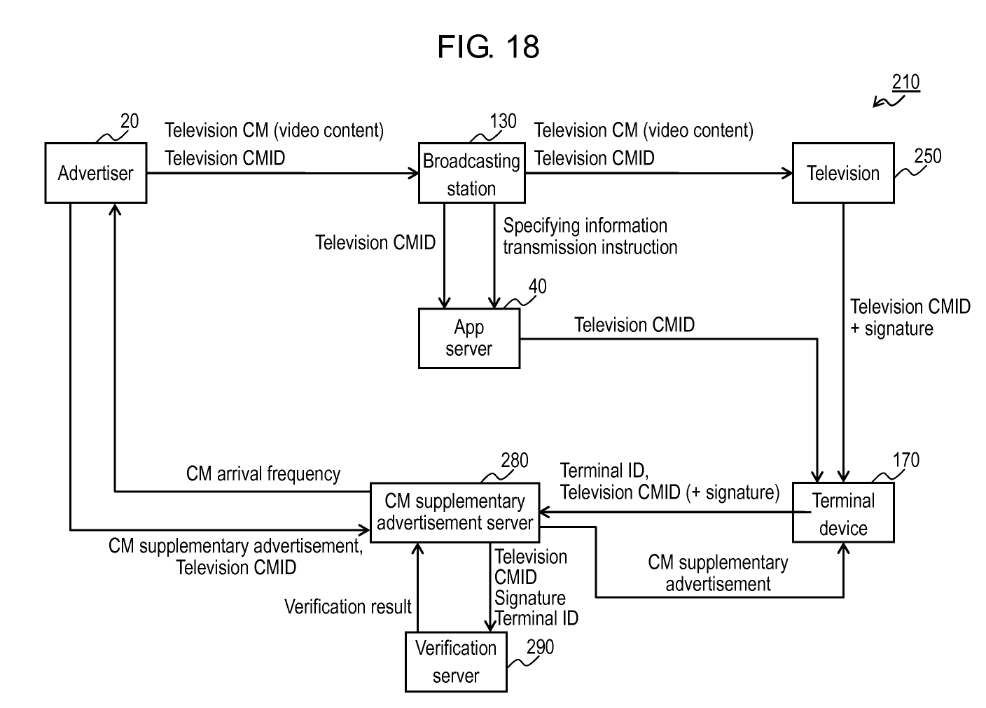

FIG. 17 is a diagram illustrating a configuration of information providing system 210 according to the present exemplary embodiment. FIG. 18 is a diagram illustrating a flow of information in information providing system 210 according to the present exemplary embodiment.

The second exemplary embodiment has described an example of imparting flag information to first specifying information via television. In the present exemplary embodiment, a digital signature is imparted to the first specifying information via television.

As illustrated in FIG. 17, information providing system 210 differs from information providing system 110 according to the second exemplary embodiment in that information providing system 210 includes television 250, terminal device 70, and CM supplementary advertisement server 280 instead of television 50, terminal device 170, and CM supplementary advertisement server 180. In addition, information providing system 210 according to the present exemplary embodiment further includes verification server 290. The following description focuses on differences from the second exemplary embodiment.

Television 250 receives a television CM and television CM ID transmitted by broadcast from broadcasting station 130. Television 250 imparts a digital signature to the received television CM ID, and transmits the television CM ID with the digital signature to terminal device 70.

CM supplementary advertisement server 280 is identical to CM supplementary advertisement server 180 according to the second exemplary embodiment, except for a different method for discriminating the received specifying information. In the present exemplary embodiment, CM supplementary advertisement server 280 discriminates which of the first specifying information and second specifying information the received specifying information is, by acquiring the digital signature imparted to the received specifying information (television CM ID).

Verification server 290 verifies the digital signature imparted to the specifying information. In the present exemplary embodiment, as illustrated in FIG. 18, verification server 290 receives the television CM ID, terminal ID, and digital signature from CM supplementary advertisement server 280, and verifies the received digital signature. Verification server 290 transmits a verification result that indicates whether the digital signature is valid to CM supplementary advertisement server 280.

For example, when the digital signature is created by a public key cryptosystem, verification server 290 holds and manages a public key for each terminal ID. Verification server 290 verifies the digital signature by considering the television CM ID and the digital signature as input and by using the public key corresponding to the terminal ID received from CM supplementary advertisement server 280.

### [3-1-2. Television (Video Receiving Device)]

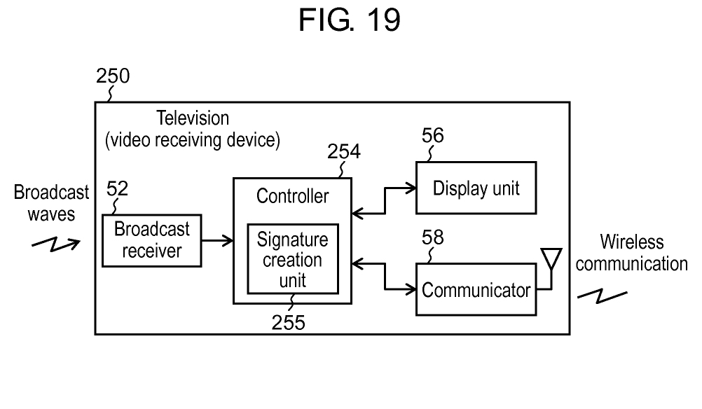

FIG. 19 is a block diagram illustrating a functional configuration of television 250 according to the present exemplary embodiment. Television 250 differs from television 50 according to the first exemplary embodiment illustrated in FIG. 4 in that television 250 includes controller 254 instead of controller 54.

Like controller 54, controller 254 is a controller that controls each component that constitutes television 250. Controller 254 includes signature creation unit 255.

Signature creation unit 255 is an example of an imparter that creates a digital signature and imparts the created digital signature to the television CM ID as identification information. That is, in the present exemplary embodiment, the identification information is the digital signature.

For example, every time television 50 receives the television CM ID, signature creation unit 255 creates the digital signature of the television CM ID by using predetermined key information. In other words, signature creation unit 255 creates the digital signature for each television CM ID.

Any method may be used for creating the digital signature. For example, signature creation unit 255 creates the digital signature in accordance with the public key cryptosystem. Specifically, signature creation unit 255 holds a private key among a key pair of the public key and the private key. On receipt of the television CM ID, signature creation unit 255 creates the digital signature by considering the received television CM ID and private key as input. Signature creation unit 255 previously generates the key pair, and previously transmits the public key to verification server 290. Alternatively, the key pair may be generated by verification server 290, and television 250 may be previously provided with the private key. This allows verification server 290 to conduct verification by using the public key.

Controller 254 transmits the television CM ID and digital signature to terminal device 70 via communicator 58.

### [3-1-3. CM Supplementary Advertisement Server]

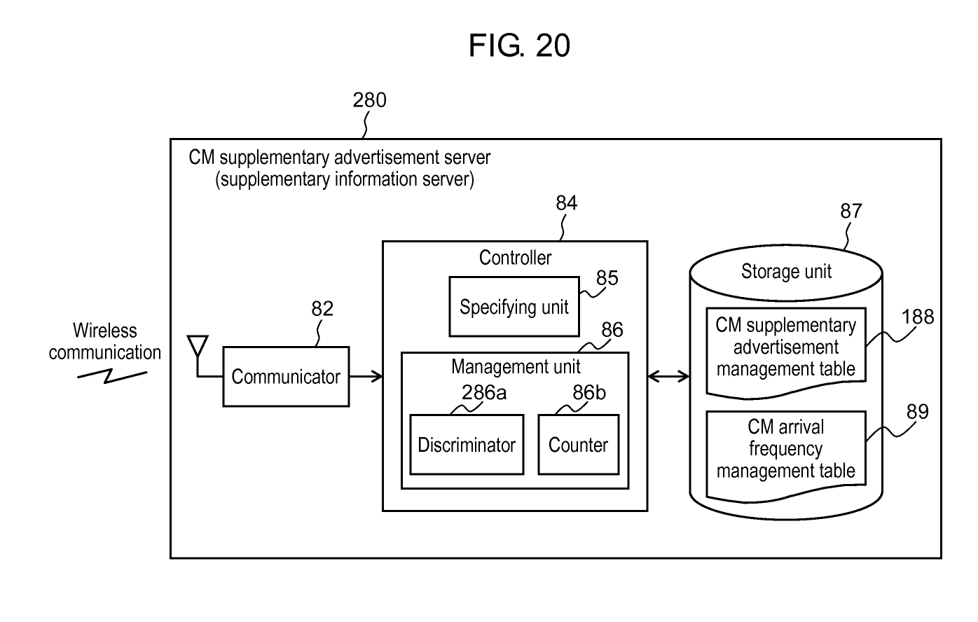

FIG. 20 is a block diagram illustrating a functional configuration of CM supplementary advertisement server 280 according to the present exemplary embodiment. CM supplementary advertisement server 280 differs from CM supplementary advertisement server 180 illustrated in FIG. 14 in that management unit 86 includes discriminator 286a instead of discriminator 186a.

Discriminator 286a discriminates between the first specifying information and the second specifying information by acquiring the digital signature. Specifically, discriminator 286a determines whether the digital signature is imparted to the television CM ID acquired by communicator 82. When the digital signature is imparted, discriminator 286a transmits the digital signature, the television CM ID, and the terminal ID to verification server 290 via communicator 82. Discriminator 286a determines that the television CM ID to which the digital signature is not imparted is the second specifying information.

Discriminator 286a acquires the verification result transmitted from verification server 290, and based on the acquired verification result, discriminates which of the first specifying information and the second specifying information the television CM ID to which the digital signature is imparted is. Specifically, when the verification result indicates that the digital signature is valid (that is, when the verification succeeds), discriminator 286a determines that the television CM ID to which the digital signature is imparted is the first specifying information terminal device 70 receives from television 250. When the verification result indicates that the verification fails, discriminator 286a determines that the television CM ID acquired by communicator 82 is tampered specifying information. When discriminator 286a determines that the television CM ID is tampered specifying information, specifying unit 85 performs operations such as stopping transmission of the CM supplementary advertisement.

### [3-2. Operation]

Next, an operation of information providing system 210 configured as described above according to the present exemplary embodiment, that is, the information providing method will be described.

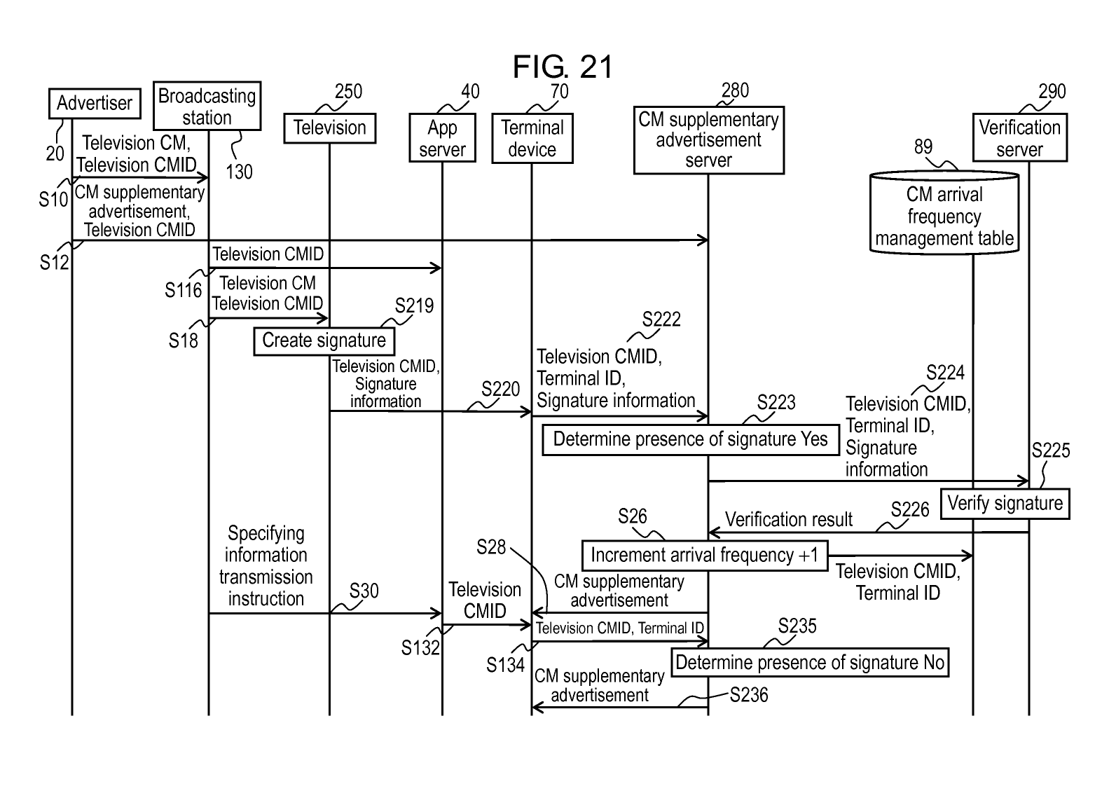

FIG. 21 is a sequence diagram illustrating the operation of information providing system 210 according to the present exemplary embodiment. In the present exemplary embodiment, pre-processing to be performed before the television CM is actually broadcasted, specifically, processing from step S10 to step S116 is identical to the processing in the second exemplary embodiment.

Next, broadcasting station 130 transmits the television CM and the television CM ID by broadcast (S18). Television 250 receives the broadcasted television CM and the television CM ID, and creates the digital signature based on the television CM ID (S219), while displaying the television CM on display unit 56. Television 250 then transmits the television CM ID and the digital signature to terminal device 70 (S220).

Terminal device 70 transmits the television CM ID, to which the digital signature is imparted, together with the terminal ID to CM supplementary advertisement server 280 (S222).

Next, in CM supplementary advertisement server 280, discriminator 286a determines presence of the digital signature (S223). That is, discriminator 286a determines whether the digital signature is imparted to the television CM ID received by communicator 82.

When the digital signature is imparted (Yes in S223), discriminator 286a transmits the television CM ID, the digital signature, and the terminal ID to verification server 290 via communicator 82 (S224).

Verification server 290 verifies the received digital signature (S225). Specifically, verification server 290 verifies the digital signature by using the public key corresponding to the received terminal ID and by inputting the television CM ID and the digital signature. Verification server 290 then transmits the verification result to CM supplementary advertisement server 280 (S226).

When CM supplementary advertisement server 280 receives the verification result indicating that the verification succeeds, counter 86b increments CM arrival frequency corresponding to the television CM ID and the terminal ID received together with the television CM ID, with reference to CM arrival frequency management table 89 (S26). Specifying unit 85 then transmits the CM supplementary advertisement specified by the received television CM ID to terminal device 70 (S28).

When CM supplementary advertisement server 280 receives the verification result indicating that the verification fails, specifying unit 85 performs operations such as stopping transmission of the CM supplementary advertisement.

Meanwhile, broadcasting station 30 transmits the specifying information transmission instruction to App server 40 (S30). Step S30 may be performed, for example, simultaneously with transmission of the television CM ID (S18).

App server 40 transmits the television CM ID to terminal device 70 with receipt of the specifying information transmission instruction as an impetus (S132). The transmitted television CM ID is received by terminal device 70 via communication network 15 and wireless router 60.

Terminal device 70 receives the television CM ID, and transmits the received television CM ID together with the terminal ID to CM supplementary advertisement server 280 (S134). In CM supplementary advertisement server 280, discriminator 286a determines presence of the digital signature (S235). Since the digital signature is not imparted to the television CM ID here, discriminator 286a may determine that the received television CM ID is the second specifying information.

Finally, specifying unit 85 transmits the CM supplementary advertisement specified by the received television CM ID to terminal device 70 (S236).

Although FIG. 21 does not illustrate period determination processing, the present exemplary embodiment may also perform the period determination processing, as in the first or second exemplary embodiment. For example, the period determination processing is performed immediately before determination processing of the presence of the digital signature (S223 or S235).

### [3-3. Summary]

As described above, in information providing system 210 according to the present exemplary embodiment, the identification information is the digital signature, signature creation unit 255 imparts the identification information to the television CM ID, and television 250 includes signature creation unit 255.

Accordingly, using the digital signature allows easy discrimination between the first specifying information and the second specifying information. Using the digital signature also allows determination of whether the television CM ID is tampered. For example, tampering of the television CM ID by malicious terminal device 70 makes it impossible to discriminate which of the first specifying information and the second specifying information the television CM ID is.

In contrast, since the present exemplary embodiment may prove that the television CM ID is the specifying information via television 250 by using the digital signature, the CM arrival frequency may be managed more accurately. Therefore, the present exemplary embodiment allows information providing system 210 to more effectively provide information, such as advertisement distribution.

For example, in the present exemplary embodiment, every time television 250 receives the television CM ID, signature creation unit 255 uses the predetermined key information to create the digital signature of the television CM ID, and imparts the created digital signature to the television CM ID as the identification information.

Accordingly, creating the digital signature every time television 250 receives the television CM ID may inhibit the digital signature from being tampered, and may make the digital signature more tamper-proof.

In the present exemplary embodiment, at a time of establishment of communication between television 250 and terminal device 70, signature creation unit 255 may previously create the digital signature by using the predetermined key information. On receipt of the television CM ID, signature creation unit 255 may impart the previously created digital signature to the received television CM ID as the identification information. For example, communication is established between television 250 and terminal device 70 when terminal device 70 starts an App.

Since this may inhibit frequency of creation of the digital signature, an amount of processing required for creation of the digital signature may be reduced.

For example, the present exemplary embodiment describes an example in which television 250 includes signature creation unit 255, but broadcasting station 130 may include signature creation unit 255. In this case, broadcasting station 130 transmits by broadcast the television CM and the television CM ID to which the digital signature is imparted. Television 250 transfers the television CM ID to which the digital signature is imparted to terminal device 70 as it is.

### Fourth Exemplary Embodiment

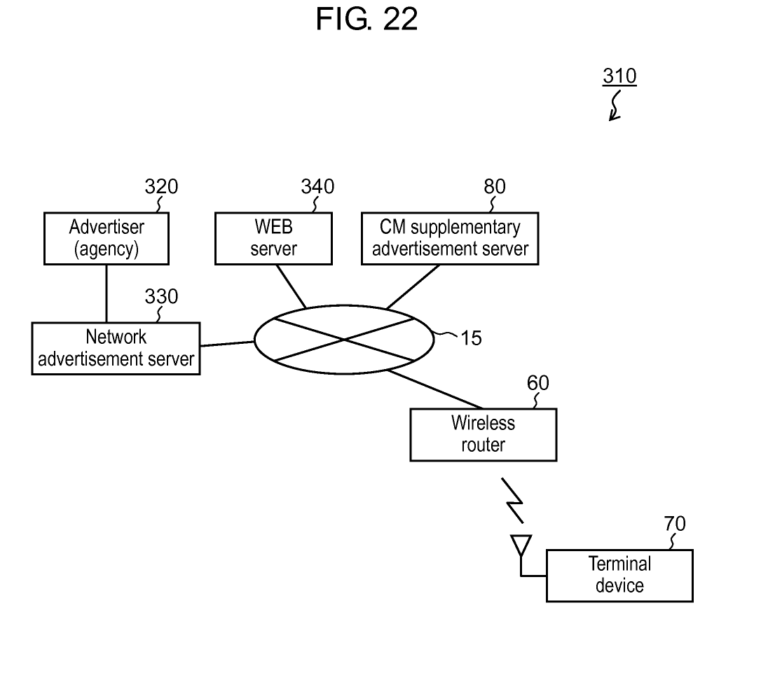

Next, an information providing system and information providing method according to a fourth exemplary embodiment will be described with reference to FIG. 22 to FIG. 25.

### [4-1. Configuration]

### [4-1-1. Overall System Configuration]

FIG. 22 is a diagram illustrating a configuration of information providing system 310 according to the present exemplary embodiment. Information providing system 310 according to the present exemplary embodiment is a system that utilizes CM arrival frequency management table 89 generated in the information providing systems described in the first to third exemplary embodiments.

As illustrated in FIG. 22, information providing system 310 includes terminal device 70, network advertisement server 330, WEB server 340, and CM supplementary advertisement server 80. In addition, information providing system 310 further includes advertiser 320 and wireless router 60. Network advertisement server 330, WEB server 340, CM supplementary advertisement server 80, and wireless router 60 are connected via communication network 15. Although unillustrated, information providing system 310 includes broadcasting station 30 and App server 40, for example.

In addition to operations according to the above-described exemplary embodiments, advertiser 320 creates a network advertisement related to a television CM. Advertiser 320 transmits the created network advertisement together with a television CM ID corresponding to the television CM to network advertisement server 330.

The network advertisement, which is an example of network information and is an advertisement related to the television CM, is not distributed in conjunction with television broadcast. Specifically, when a predetermined WEB site is accessed using terminal device 70 or other apparatuses, the network advertisement is displayed together with the WEB site. For example, the network advertisement is a banner advertisement displayed on the WEB site.

Network advertisement server 330 is an example of a network information server. When a predetermined condition is satisfied by CM arrival frequency corresponding to the television CM associated with a network advertisement selected from among one or more network advertisements respectively associated with television CM IDs, network advertisement server 330 distributes the selected network advertisement. In the present exemplary embodiment, network advertisement server 330 holds one or more network advertisements transmitted from one or more advertisers 320. Network advertisement server 330 selects the network advertisement to be distributed from among the one or more network advertisements, and determines whether to distribute the selected network advertisement to terminal device 70 based on the predetermined condition. Network advertisement server 330 is connected to terminal device 70 via communication network 15.

WEB server 340 is a server that manages the WEB site. Specifically, in response to a request for the WEB site from terminal device 70, WEB server 340 transmits the WEB site to terminal device 70. In the present exemplary embodiment, WEB server 340 inquires of network advertisement server 330 about the network advertisement to be displayed on the WEB site. WEB server 340 transmits to terminal device 70 the WEB site including the network advertisement transmitted from network advertisement server 330 in response to the inquiry.

### [4-1-2. Network Advertisement Server (Network Information Server)]

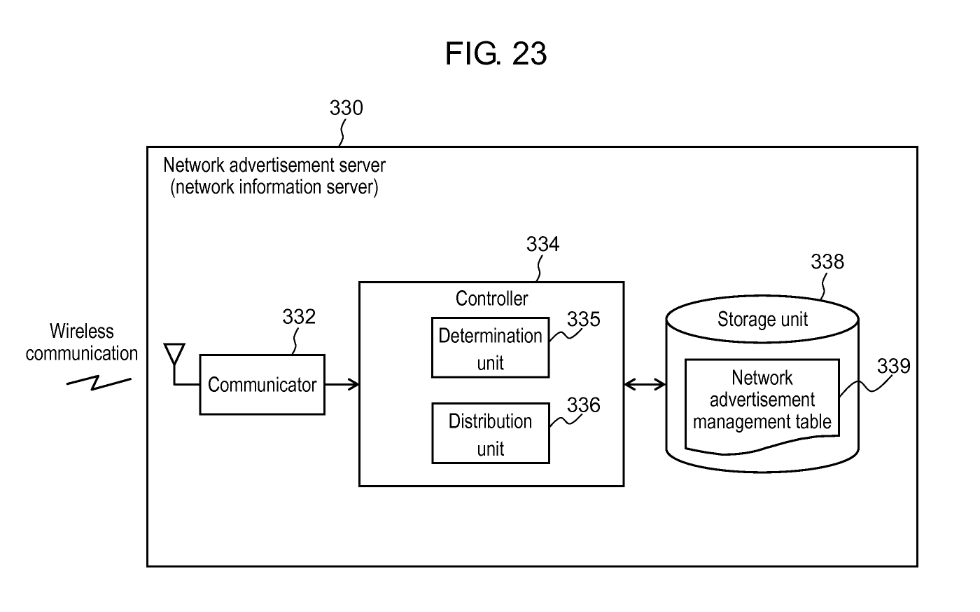

FIG. 23 is a diagram illustrating a functional configuration of network advertisement server 330 according to the present exemplary embodiment. Network advertisement server 330 includes communicator 332, controller 334, and storage unit 338.

Communicator 332 is a communication interface connected to communication network 15, communicating with terminal device 70 via wireless router 60. In the present exemplary embodiment, communicator 332 communicates with terminal device 70, WEB server 340, and advertiser 320 in accordance with control by controller 334.

For example, communicator 332 receives, from WEB server 340, a request for the network advertisement and a terminal ID transmitted from terminal device 70. Communicator 332 also transmits to WEB server 340 the network advertisement selected for distribution. Communicator 332 also transmits the television CM ID and the terminal ID to CM supplementary advertisement server 80, and in response to the television CM ID and the terminal ID, receives the CM arrival frequency corresponding to the transmitted television CM ID and the terminal ID.

Controller 334 is a controller that controls each component that constitutes network advertisement server 330, and includes components such as a nonvolatile memory that stores a program, a nonvolatile memory that is a temporary storage area for executing the program, an input-output port, and a processor that executes the program. In the present exemplary embodiment, controller 334 includes determination unit 335 and distribution unit 336.

Determination unit 335 selects one network advertisement from one or more network advertisements, and determines whether the CM arrival frequency associated with the selected network advertisement satisfies the predetermined condition. The one or more network advertisements are managed in network advertisement management table 339 held in storage unit 338.

Any criteria may be used for selecting the network advertisement. For example, determination unit 335 may select the network advertisement based on personal information on a user, such as preference information and a watching history, or may select the network advertisement in accordance with an agreement with advertiser 320.

In the present exemplary embodiment, determination unit 335 determines whether the CM arrival frequency is less than a predetermined threshold. When the CM arrival frequency is less than the threshold, determination unit 335 determines that the condition is satisfied, and when the CM arrival frequency is equal to or greater than the threshold, determination unit 335 determines that the condition is not satisfied. Determination unit 335 then outputs a determination result to distribution unit 336.

When determination unit 335 determines that the condition is satisfied, distribution unit 336 distributes the selected network advertisement to terminal device 70. In the present exemplary embodiment, distribution unit 336 refers to network advertisement management table 339 to acquire the network advertisement, and transmits the network advertisement via communicator 332. When determination unit 335 determines that the condition is not satisfied, distribution unit 336 selects and transmits a different network advertisement to terminal device 70. At this time, determination unit 335 may determine whether the different network advertisement satisfies the condition.

Storage unit 338 is a storage device that holds network advertisement management table 339. Storage unit 338 is, for example, a HDD or a semiconductor memory such as a flash memory.

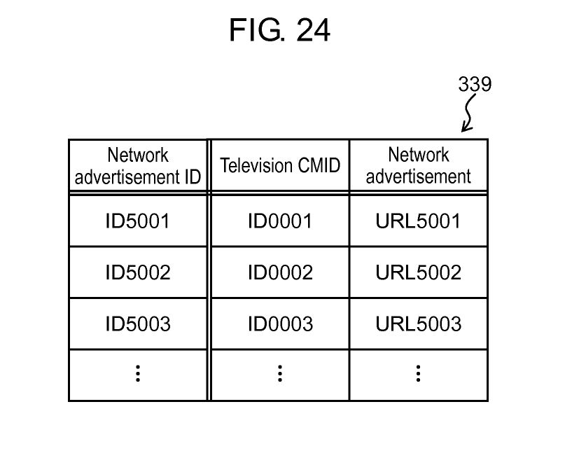

FIG. 24 is a diagram illustrating network advertisement management table 339 according to the present exemplary embodiment.

As illustrated in FIG. 24, network advertisement management table 339 associates the television CM ID and the network advertisement with the network advertisement ID. The network advertisement ID is an identifier allocated for each network advertisement. Network advertisement management table 339 associates, as the network advertisement, a URL that indicates an actual file of the network advertisement, for example, with the network advertisement ID.

### [4-2. Operation]

Next, an operation of information providing system 310 configured as described above according to the present exemplary embodiment, that is, an information providing method will be described.

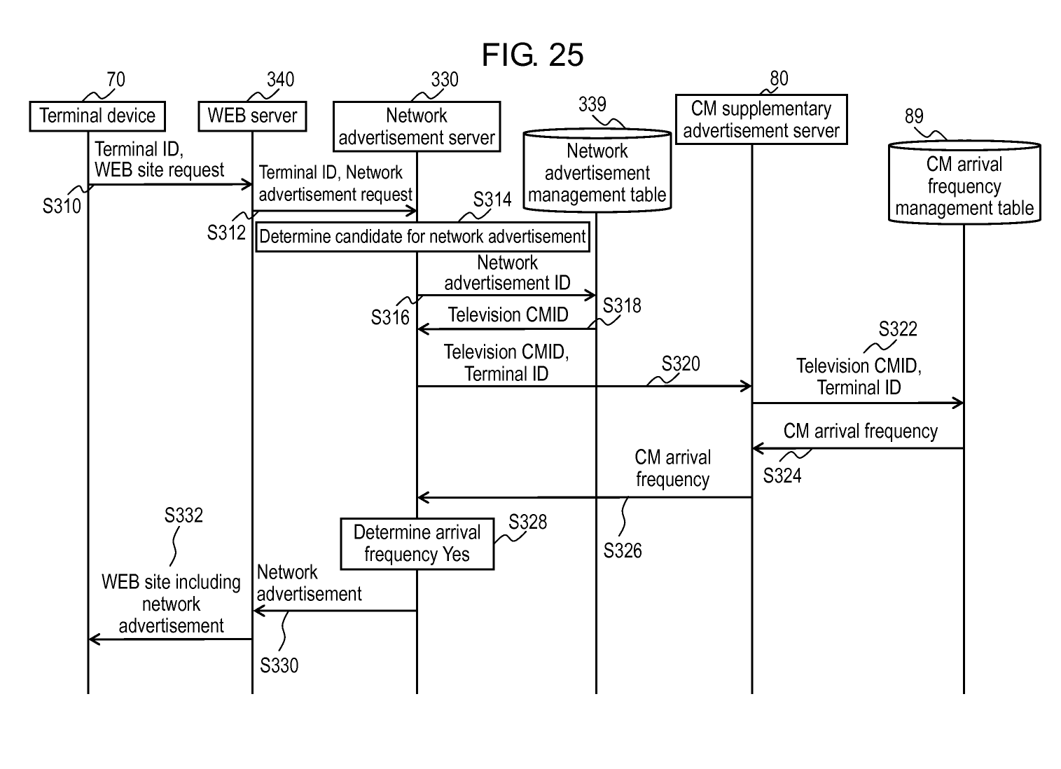

FIG. 25 is a sequence diagram illustrating the operation of information providing system 310 according to the present exemplary embodiment.

First, terminal device 70 transmits the terminal ID and the request for the WEB site to WEB server 340 (S310). For example, terminal device 70 includes an installed App for viewing WEB sites, such as a web browser, and executes the App to transmit the terminal ID and the request to WEB server 340.

Next, WEB server 340 transmits the terminal ID transmitted from terminal device 70 and the request for the network advertisement to network advertisement server 330 (S312). The request for the network advertisement is an instruction that requires the network advertisement to be displayed on a predetermined region within the WEB site, for example.

In response to the request for the network advertisement, network advertisement server 330 determines a candidate for the network advertisement (S314). Specifically, in network advertisement server 330, determination unit 335 selects one network advertisement from among one or more network advertisements.

Next, determination unit 335 outputs the network advertisement ID corresponding to the selected network advertisement to network advertisement management table 339 (S316). Determination unit 335 acquires the television CM ID corresponding to the network advertisement ID from network advertisement management table 339 (S318), and transmits the acquired television CM ID and the terminal ID to CM supplementary advertisement server 80 (S320).

CM supplementary advertisement server 80 refers to CM arrival frequency management table 89 (S322), and acquires the CM arrival frequency corresponding to a combination of the received television CM ID and the terminal ID (S324). CM supplementary advertisement server 80 transmits the acquired CM arrival frequency to network advertisement server 330 (S326).

In network advertisement server 330, determination unit 335 determines whether the CM arrival frequency transmitted from CM supplementary advertisement server 80 satisfies the predetermined condition (S328). When it is determined that the CM arrival frequency satisfies the predetermined condition (Yes in S328), network advertisement server 330 transmits the network advertisement determined in step S314 to WEB server 340 (S330). When the CM arrival frequency does not satisfy the predetermined condition, network advertisement server 330 transmits another network advertisement to WEB server 340.

WEB server 340 transmits the WEB site including the received network advertisement to terminal device 70 (S332). This causes terminal device 70 to display the WEB site including the network advertisement.

### [4-3. Summary]

As described above, information providing system 310 according to the present exemplary embodiment further includes network advertisement server 330. When the predetermined condition is satisfied by the CM arrival frequency corresponding to the television CM ID associated with the network advertisement selected from among one or more network advertisements respectively associated with the television CM IDs, network advertisement server 330 distributes the selected network advertisement.

This allows information providing system 310 to perform advertisement distribution according to the CM arrival frequency.

For example, when the CM arrival frequency of the television CM is equal to or greater than a threshold (for example, 10 times), the network advertisement related to the television CM is not distributed and another network advertisement is distributed instead. This may inhibit excessive advertisement distribution and may inhibit a user from being bored.

On the other hand, when the CM arrival frequency of the television CM is less than the threshold, the network advertisement related to the television CM is distributed. This may supplement an advertising effect by the network advertisement when the advertising effect of the television CM to the user is not sufficient.

Thus, the present exemplary embodiment allows information providing system 310 to effectively provide information, such as advertisement distribution.

### Other Exemplary Embodiments

As described above, the exemplary embodiments have been described by way of example of a technique to be disclosed in the present application. The technique in the present disclosure, however, is not limited to the examples, and may be applied to exemplary embodiments to which appropriate change, replacement, addition, and omission are made. In addition, it is also possible to make a new exemplary embodiment by combining components described in the above-described exemplary embodiments.

Therefore, other exemplary embodiments will be described below.

For example, in the first exemplary embodiment, broadcasting station 30 creates and transmits supplementary advertisement specifying information to App server 40. However, advertiser 20 may create the supplementary advertisement specifying information. In this case, advertiser 20 may transmit the television CM and the television CM ID to broadcasting station 30, and may transmit the CM supplementary advertisement and the supplementary advertisement specifying information to App server 40.

For example, each of the above-described exemplary embodiments has described an example in which CM supplementary advertisement server 80 includes management unit 86, but management unit 86 is not limited to this example. Another apparatus different from CM supplementary advertisement server 80 (for example, App server 40) may include management unit 86. Alternatively, terminal device 70 may include management unit 86. In this case, management unit 86 may manage only the CM arrival frequency of terminal device 70, without managing the CM arrival frequency of other terminal devices.

For example, each of the above-described exemplary embodiments manages frequency of receiving specifying information from television 50 as the CM arrival frequency, but may also manage frequency of receiving specifying information from App server 40.

For example, each of the above-described exemplary embodiments has described an example of utilizing the CM arrival frequency managed by the information providing system according to each of the above-described exemplary embodiments for distribution of network advertisements, but usage of the CM arrival frequency is not limited to this example. The CM arrival frequency may be used for determination related to various kinds of information provision, such as determination of frequency of broadcasting a television CM.

For example, each of the above-described exemplary embodiments has described an example in which App server 40 and CM supplementary advertisement server 80 are separate devices, but App server 40 may be identical to CM supplementary advertisement server 80. Similarly, for example, in the fourth exemplary embodiment, network advertisement server 330 may be identical to CM supplementary advertisement server 80.

For example, each of the above-described exemplary embodiments has described the television including a display unit as an example of the video receiving device, but the video receiving device is not limited to this example. For example, the video receiving device may be a device such as a STB (Set Top Box) that does not include a display unit, and may output the television CM to an external display.

For example, as one aspect according to the present disclosure, among the steps included in the above-described information providing method, steps to be performed by each device such as television 50 and CM supplementary advertisement server 80 may be implemented as a program to be executed by a processor included in each device.

The above-described program may be recorded in a recording medium to be distributed or circulated. For example, installing the distributed program in devices and causing processors of the devices to execute the program makes it possible to cause the devices to perform various kinds of processing.

Part or all of the components that constitute each of the above-described devices may include one system LSI (Large Scale Integration). The system LSI is a super-multifunctional LSI manufactured by integration of a plurality of elements on one chip, and specifically is a computer system that includes a microprocessor, a ROM, a RAM, etc. The ROM stores the computer program. The system LSI achieves functions thereof by the microprocessor loading the computer program from the ROM to the RAM and executing operations such as calculation in accordance with the loaded computer program.

As described above, the exemplary embodiments have been described by way of example of the technique in the present disclosure. For this purpose, the accompanying drawings and detailed description have been provided.

Therefore, the components described in the accompanying drawings and detailed description may include not only components essential for solving problems but also components unessential for solving problems, in order to illustrate the above-described technique. Therefore, it should not be acknowledged immediately that those unessential components be essential because those unessential components are described in the accompanying drawings and detailed description.

In addition, since the above-described exemplary embodiments are for illustrating the technique in the present disclosure, various changes, replacements, additions, omissions, etc. may be made within the scope of the appended claims and equivalents thereof.

The information providing system and the like according to the present disclosure may be used for a system that provides supplementary information in parallel with broadcast of video content. For example, the information providing system according to the present disclosure may be used for so-called multiscreen broadcast, etc. that displays CM supplementary advertisements on portable terminals, such as a smart phone, in parallel with broadcast of television programs.

What is claimed is:

1. An information providing system for providing broadcast of video content and supplementary information related to the video content, the information providing system comprising:
a supplementary information server that provides supplementary information specified from among one or more pieces of supplementary information respectively related to one or more pieces of video content to be broadcasted;
a video receiving device that receives, via broadcast, one of the one or more pieces of video content and first specifying information for specifying the one of the one or more pieces of supplementary information related to the video content;
a terminal device that receives the first specifying information from the video receiving device, and second specifying information for specifying the one of the one or more pieces of supplementary information from another apparatus different from the video receiving device; and
a management unit that discriminates between the first specifying information and the second specifying information, and manages frequency with which the terminal device receives the first specifying information.

2. The information providing system according to claim 1, wherein the first specifying information and the second specifying information are pieces of information different from each other, specifying identical one of the one or more pieces of supplementary information.

3. The information providing system according to claim 1, further comprising an imparter that imparts identification information for identifying the first specifying information and the second specifying information to either one of the first specifying information and the second specifying information, wherein
the first specifying information and the second specifying information are identical information, and
the management unit comprises a discriminator that discriminates between the first specifying information and the second specifying information by acquiring the identification information, and a counter that counts the frequency based on a discrimination result by the discriminator.

4. The information providing system according to claim 3, wherein the identification information is a digital signature.

5. The information providing system according to claim 4, wherein
the video receiving device comprises the imparter, and
the imparter:
creates the digital signature previously by using predetermined key information at a time of establishment of communication between the video receiving device and the terminal device, and
imparts the previously created digital signature to the received first specifying information as the identification information on receipt of the first specifying information.

6. The information providing system according to claim 4, wherein the imparter creates the digital signature by using predetermined key information every time the video receiving device receives one of the first specifying information and the second specifying information.

7. The information providing system according to claim 3, further comprising a transmitting device that transmits via broadcast the video content and the first specifying information, wherein
the transmitting device comprises the imparter, and
the imparter imparts the identification information to the first specifying information.

8. The information providing system according to claim 3, wherein the identification information is flag information that indicates that the terminal device receives the first specifying information.

9. The information providing system according to claim 1, wherein
the supplementary information server comprises the management unit, and
the terminal device transmits:
one of the first specifying information and the second specifying information to the supplementary information server; and
the supplementary information specified by one of the first specifying information and the second specifying information to the terminal device.

10. The information providing system according to claim 1, further comprising a network information server, wherein, when a predetermined condition is satisfied by the frequency corresponding to the first specifying information associated with network information selected from among one or more pieces of network information each associated with the first specifying information, the network information server distributes the selected network information.

11. The information providing system according to claim 1, wherein the management unit manages the frequency for each piece of the video content and each of the terminal device.

12. The information providing system according to claim 1, wherein, on receipt of one of the first specifying information and the second specifying information, the supplementary information server determines whether a predetermined period of time has elapsed after transmission of the one of the one or more pieces of supplementary information specified by one of the first specifying information and second specifying information received before, and transmits the one of the one or more pieces of supplementary information again only when the predetermined period of time has elapsed.

13. The information providing system according to claim 1, wherein
the one of the one or more pieces of video content is a commercial message, and
the one of the one or more pieces of supplementary information is advertisement supplementary information that indicates information on the commercial message in detail.

14. An information providing method for providing broadcast of video content and supplementary information related to the video content, the information providing method comprising:
receiving via broadcast, by a video receiving device, the video content and first specifying information for specifying the supplementary information related to the video content;
transmitting, by a terminal device, the first specifying information to a supplementary information server, on receipt of the first specifying information from the video receiving device, and transmitting second specifying information to the supplementary information server, on receipt of the second specifying information for specifying the supplementary information from another apparatus different from the video receiving device;
transmitting to the terminal device, by the supplementary information server, the supplementary information specified with one of the first specifying information and the second specifying information received from the terminal device, from among one or more pieces of supplementary information respectively related to one or more pieces of video content to be broadcasted; and
discriminating, by a management unit, between the first specifying information and the second specifying information to manage frequency with which the terminal device receives the first specifying information.
